(19) United States
(12) Patent Application Publication
(10) Pub. No.: US 2016/0078264 A1
(43) Pub. Date: Mar. 17, 2016

(54) REAL TIME ELECTRONIC ARTICLE SURVEILLANCE AND MANAGEMENT

(71) Applicant: SENITRON CORP., Beverly Hills, CA (US)

(72) Inventors: John T. Armstrong, Sierra Madre, CA (US); Peter A. Carah, Altadena, CA (US)

(21) Appl. No.: 14/889,832

(22) PCT Filed: May 7, 2013
(86) PCT No.: PCT/US13/39960

§ 371 Date: Nov. 6, 2015

Related U.S. Application Data
(60) Provisional application No. 61/643,715, filed on May 7, 2012.
(60) Provisional application No. 61/703,920, filed on Sep. 21, 2012.

(51) Int. Cl. G06K 7/10

(52) U.S. Cl. CPC G06K 7/10475; G06K 7/10415; G06K 7/10356

(57) ABSTRACT

A real time electronic article surveillance system that can identify individual items with an RFID tag affixed and track the items using one or more than one computer communicatively connected to RFID detectors, at least one display and audio visual device operably connected to each other using network and peripheral interfaces. The computers comprising instructions for performing real time inventory and analysis of at least 90% of all the RFID tags and storing the inventory and analysis in a database by a user using a user interface.

### CROSS-REFERENCE TO RELATED APPLICATION

This application claims priority to and the benefit of U.S. Provisional Application No. 61/643,715, filed on May 7, 2012 and U.S. Provisional Application No. 61/703,920, filed on Sep. 21, 2012 in the United States Patent and Trademark Office.

### FIELD OF THE INVENTION

The present invention relates to the field of electronic article surveillance (EAS), and more specifically to a real time electronic article surveillance system that can identify individual items and track the items that is inexpensive and accurate.

### BACKGROUND

There are many different types of electronic article surveillance presently available for reducing or eliminating inventory shrinkage. However, the current systems suffer from a variety of drawbacks so that they do not adequately protect retailers from the three most common means of undetected store theft: customer theft, employee theft and cooperative theft.

Current systems utilize simple electronic markers (tags or hard tags) to indicate the presence of an object. The sensor positioned at the exit area of the store. These tags must be deactivated at time of checkout, or otherwise be detached from the purchased items. These hard tags are detached and recycled and must be manually replaced on new items by store employees. This additional cost can be prohibitive. These hard tags can be detected at the exit of the store and can set off an audible alarm, alerting both the patron and store security that a hard tag has left, or entered the premises. These hard tag systems are primarily a deterrent and are seldom used in enforcement due to the attendant liability from a relatively high false alarm rate and concerns over customer responses.

Other electronic product code (EPC) systems utilize a complex electronic marker, such as, for example, an RFID tag, that is capable of passing additional tracking or store related information to a remote tag reader. For example, current RFID tags can alert a store to the presence or non-presence of the tag and some basic information. But not every successful reading of a tag (observation) represents data useful for the purposes of a business. A large amount of data may be generated that is not useful for managing inventory or other applications. For example, a customer moving a product from one shelf to another, or a pallet load of articles that passes several readers while being moved in a warehouse, are events that do not produce data that is meaningful to an inventory control system.

Event filtering is required to reduce this data inflow to a meaningful depiction of moving goods passing a threshold. Although various concepts have been designed to increase the usefulness of this data, current system are mainly offered as middleware performing the filtering from noisy and redundant raw data to significant processed data. This amount of filtering reduces the usefulness of the RFID tags. Additionally, the cost associated with being able to read RFID tags over an extended area are prohibitive.

Typically, human ‘floor walkers’ in concert with traditional EAS sensors have been used to accomplish a reduction in theft. The present system extends these capabilities without being burdensome to the store, and without being obvious to the customer. The present system does not use as much floor space as conventional EAS systems, and the ability to communicate via cellphone or Internet to individuals, means that the number of personnel needed to monitor a store is decreased.

Additionally, Best Buy, Costco, and others, employ ‘door checkers’—people who look at receipts and the items on the cart. When used with full EPC item level tagging, this can all be automated using the invention described herein, further enhancing shopper experience without losing security.

Therefore, there is a need for a real time electronic article surveillance system that can identify individual items and track the items that is inexpensive and accurate.

### SUMMARY OF THE INVENTION

The present invention overcomes the limitations of the prior art by providing a real time electronic article surveillance system that can identify individual items and track the items. The system comprises one or more than one computer; one or more than one RFID detector communicatively connected to the one or more than one computer; one or more than one display operably connected to the one or more than one computer; one or more than one audio visual devices operably connected to the one or more than one computer; one or more than one network and peripheral interface operably connected to the one or more than one computer; one or more than one RFID tag affixed to one or more than one article communicatively coupled to the one or more than one computer; and instructions executable on the one or more than one computer. The instruction execute areal time inventory and analysis of at least 90% of all the one or more than one RFID tag affixed to one or more than one article; a database; and a user interface. The audio visual devices are selected from the group consisting of microphones, speakers and video cameras. The network and peripheral interfaces are selected from the group consisting of USB, WiFi, Ethernet, Bluetooth, cellphone and Internet access. The RFID tag can be a custom EPC RFID tag

The RFID detector can be selected from the group consisting of a baseboard antenna sensor, a distributed antenna, a leaky wave antenna, a decorative molding antenna sensor, a rail antenna, a sub-floor antenna sensor, a dual RFID antenna, a single RFID antenna with dual independent feeds and a bistatic antenna reader.

The system further comprises a mobile antenna mounting bracket useful for mounting, pointing and relocating RFID antennas to increase the RFID antennas' effectiveness and coverage. The bracket comprises a sliding track for positioning RFID antennas; a horizontal swivel point affixed to a support member connectable to the sliding track for turning the antenna about a horizontal axis; a first and a second swivel point connected for adjusting the antenna in a vertical plane 90° relative to the horizontal plane without introducing torque on the suspension system; and an antenna attachment bracket for quickly attaching an antenna to the bracket. The first and second swivel points are a quick connect and disconnect point for mounting the antenna attachment bracket and the swivel points also comprise a locking mechanism to maintain the RFID antenna at a set angle in the vertical plane.

The system further comprises a multi-connector RF antenna hub that comprises a plurality of cable connectors. In a preferred embodiment, the multi-connector RF antenna hub comprises eight cable connectors.

The system further comprises a custom EPC RFID tag operable for directed messaging communicatively coupled to the one or more than one computer; general messaging communicatively coupled to the one or more than one computer; store advertisements communicatively coupled to the one or more than one computer; promotions communicatively coupled to the one or more than one computer; entertainment communicatively coupled to the one or more than one computer; safety messaging communicatively coupled to the one or more than one computer; and general store information communicatively coupled to the one or more than one computer. The general store information comprises maps, location of goods and location of services.

The system also comprises one or more than one rounder communicatively coupled to the one or more than one computer; one or more than one cameras communicatively coupled to the one or more than one computer; one or more than one cash register with at least one sensor attached to the cash register communicatively coupled to the one or more than one computer; and one or more than one RFID detectors placed throughout the store all communicatively coupled to the one or more than one computer. The system also has one or more than one portable RFID scanner to determine the location of articles.

There is also provided a method of using a real time electronic article surveillance system that can identify individual items and track the items. The method comprises the steps of: a) providing the system of claim 1; b) initializing the system including all scanners, readers and credit card systems; c) setting all amounts are set to zero; d) deactivating all buttons; e) clearing all images from displays and information areas; f) clearing readers; g) detecting ID's of items by a scanner; h) storing the item ID's detected by the scanner in a storage; i) displaying information and an image of the item detected; j) determining if the checkout procedure is successful; k) adding the items detected to a total; l) determining if all items have been processed; m) displaying a total payment due; and n) processing processed the payment completing the transaction. The method also comprises the steps of: a) determining if assistance is needed after step j); b) pressing a button to request help; c) providing help. The method further comprises the steps of: a) pressing an add or subtract item button; b) displaying all items scanned and available items; c) scrolling through the displayed items until a match is found; d) adding a missing item; e) subtracting an item not present; f) determining if all items have been processed; g) calculating and displaying a total payment due; and h) processing the payment due completing the transaction. The RFID detector comprises instructions operable on a processor to poll the RFID reader for tags.

There is also provided a method of using a real time electronic article surveillance system that can identify individual items and track the items. The method comprising the steps of: a) providing the system of claim 1; b) executing instructions stored in a storage on the one or more than one computer for: 1) polling the RFID reader for tags; 2) monitoring RFID reader events and protects for one second; 3) parsing a returned list of tags detecting enter and leave events on an EPC identification basis; 4) adding the events to a log file; 5) inputting the events into a database; 6) providing event indications to door monitors and cash registers; and 7) searching and inventory database and identifying articles detected by the RFID detectors. The method further comprises the steps for: a) detaching articles scanned at a cash register; b) removing from the database the articles scanned; c) displaying an image and a price of the articles scanned from an inventory database; d) reviewing each article visually by comparing the article with the display; e) adjusting incorrect amounts; f) adjusting incorrect prices; g) totaling the price of all articles scanned; j) receiving payment for all articles scanned; and k) updating the inventory database removing the articles after receiving payment. Additionally, the method comprises the steps of: a) detecting all the tags as a customer exits the store; b) imaging each customer exiting the store; c) determining if the items match the cashier identification of items sold; and d) sending then the image to security personnel. Also provided is an audible alarm, a visual alarm or both and audio and visual alarm are activate notifying the customer and security personnel that an ID is being removed that has not been detached. The events monitored comprise entrance and egress of RFID tagged articles for a location, movement of RFID tagged article; counting RFID tagged articles and identifying RFID tagged articles.

There is also provided a real time electronic article surveillance system that can identify individual items and track the items. The system comprises one or more than one electronic product code radio-frequency identification reader, one or more than one controlled filter used when processing the EPC RFID tags electronically connected to the one or more than one reader to track items comprising an improved RFID tag, one or more than one computer communicatively connected to the EPC RFID reader, one or more than one display operably connected to the one or more than one computer, one or more than one network and peripheral interface operably connected to the one or more than one computer, one or more than one RFID tag affixed to one or more than one article communicatively coupled to the one or more than one computer, and instructions executable on the one or more than one computer for real time inventory and analysis of at least 90% of all the one or more than one RFID tag affixed to one or more than one article. The controlled filter is an ItemTagEAS filter, where the ItemTagEAS filter is operable to identify a store owning a RFID tag and counting the number of tags. The computer comprised a database, where the database comprises database fields for: a track leave event times field; a location field of one or more than one RFID reader where a detection occurred; a photograph field; and an audio file field. The system further comprises RFID reader counts of tags allowing an item count to be performed easily and often. All monitoring functions can be transmitted to a location.

The system further comprising instructions for counting the number of RFID tags in a location, correlating the count with register purchases, automating customer checkout using Item Level tagging capabilities of the RFID tag, and calculating and displaying metrics selected by a user, where the metrics also can comprise a date range. The RFID tags can be either passive, semi-active or both active and semi-active tags. Each antenna located throughout the store can individually identify and distinguish RFID tags on a per antenna basis.

There is also provided a method of using a real time electronic article surveillance system that can identify individual items and track the items comprising the steps of: a) providing the system of claim 18; b) executing instructions stored in a storage on the one or more than one computer. The instructions can be executed for: 1) polling the RFID reader for tags; 2) parsing a returned list of tags detecting enter and leave events on an EPC identification basis; 4) adding the events to a log file; 5) inputting the events into a database; 6) providing event indications to door monitors and cash registers; 7) searching and inventory database and identifying articles detected by the RFID detectors; and 8) providing a user interface. The user interface can display a layout of a location comprising RFID tagged articles, a layout of a location comprising RFID tagged articles and also display one or more than one sales zones and sales by zones.

The user interface can also be configure to display a sales tab, an alert tab and a locate tab. The sales tab can display information on retail sales for each zone. The alert tab can display information designated by a user to trigger an alert, where the alerts can be selected from the group consisting of loss prevention, inventory movement and inventory shortage. The alert threshold can be set by a user. The locate tab can display information to locate inventory location covered by the system. Each tab can display one or more than one metric. 49. The method of claim 48, where the one or more than one metric displayed can comprise a positioned to sell percentage metric, a date range metric, a style metric, a category metric, a sales by zone metric, a quantity of goods by style metric, a quantity metric, a total sales metric, a loss prevention metric, a shrinkage metric, a location by category of goods for each zone metric, a sales by category for each zone metric. The metric can be displayed as a graphic, color coded, or as an alert popup.

There is also provided a method for a real time electronic article surveillance system that can identify individual items and track the items, comprising the steps of: a) using a hand-held RFID scanner in combination with the system of claim 1; b) providing instructions executable on a processor. The instructions can be executed for: 1) reading floor inventory using the hand held scanner; 2) storing the read tag information to a database; 3) executing an algorithm to detect out of place items, where an out of place item is any item that is geographically in the wrong location, where the algorithm comprises instructions for reading SKU information from the hand held scanner and determining if any of the SKU information read by the hand held scanner is an out of place item; 4) transmitting an alert to the employee indicating that the out of place item should be removed from its found location to a predetermined location; 5) Identifying the RFID tag of the out of place item; 6) determining if the tag is not identified and transmitting an alert to the employee to remove the item; 7) determining the out of place item's position; 8) determining if the out of place item is being read at a reference location where it does not belong and transmitting an alert to the employee to remove the out of place item; and 10) re-reading all removed items RFID tags and transmitting instructions to the employee to take action regarding the out of place items.

There is also provided a method for a real time electronic article surveillance system that can identify individual items and track the items, comprising the steps of: a) providing instructions executable on a processor for: 1) reading a tag location; 2) determining if an item associated with the tag is set is not correct; 3) alerting an employee to verify and replace item if actually missing if the location is not correct; 4) creating a report listing variances from expected stock profile to measured stock profile; 5) verifying antenna diversity to verify antenna polarization; 6) passing a pseudo-tag that responds to the one or more than one readers like standard RFID tag; 7) determining the amount of energy is being received providing using the pseudo-tag to provide detection of dark areas where tags will not be seen; 8) performing a tag survey, using information coded into EPC, pseudo-tag or both EPC and pseudo-tag memory to record the energy measurement directly into the database, via the reader; and 9) providing immediate feedback with operator information for tuning the one or more than one reader's sensitivity and power levels for a given location. The method further comprising instructions for surveying the active readers on the floor. The method further comprising instructions for surveying marker, signpost, or both marker and signpost tags on furniture and building structures to provide location metrics, where the tags automatically add, remove or both add and remove furniture and building structures in the affected merchandizing zones.

### BRIEF DESCRIPTION OF THE DRAWINGS

These and other features, aspects and advantages of the present invention will become better understood with regard to the following description, appended claims, and accompanying figures where:

FIG. 1 is a diagram of a retail store implementation of a real time in-store electronic article surveillance system according to one embodiment;

FIG. 2 is a flowchart diagram of a retail store implementation of an in-store electronic article surveillance system;

FIG. 3 is a screenshot diagram of a user interface displaying sales by zones for a retail store, according to one embodiment;

FIG. 4 is a screenshot diagram of a user interface displaying sales by zones for a retail store, according to another embodiment;

FIG. 5 is a screenshot diagram of a user interface displaying quantity of goods by style for each zone of a retail store;

FIG. 6 is a screenshot diagram of a user interface displaying the location by style of goods for each zone of a retail store;

FIG. 7 is a screenshot diagram of a user interface displaying the location by category of goods for each zone of a retail store;

FIG. 8 is a screenshot diagram of a user interface displaying sales by category for each zone of a retail store;

FIG. 9 is a screenshot diagram of a user interface displaying sales by style for each zone of a retail store;

FIG. 10 is a screenshot diagram of a user interface displaying alerts for each zone of a retail store;

FIG. 11 is a screenshot diagram of a user interface displaying an alert popup for a selected zone of a retail store;

FIG. 12 is a screenshot diagram of a user interface displaying item details for all zones of a retail store;

FIG. 13 is a screenshot diagram of a user interface displaying item details for a selected zone of a retail store;

FIG. 14 is a diagram of a baseboard antenna sensor for RFID tag location;

FIG. 15 is a diagram of a decorative molding antenna sensor for RFID tag location;

FIG. 16 is a diagram of a sub-floor antenna sensor for RFID tag location;

FIG. 17 is a diagram of a leaky wave sub-floor antenna sensor for RFID tag location;

FIG. 18 is a diagram of a dual RFID antenna useful for tag identification;

FIG. 19 is a diagram of a single RFID antenna with dual independent feeds useful for tag identification;

FIG. 20 is a diagram of a mobile antenna mounting bracket useful for mounting, pointing and relocating RFID antennas to increase the RFID antennas' effectiveness and coverage;

FIG. 21 is a diagram of the mobile antenna mounting bracket of FIG. 21 attached to an RFID antenna;

FIG. 22 is a diagram showing the mobile antenna mounting bracket of FIG. 9 attached to an RFID antenna and repositioning the RFID antenna;

FIG. 23 is a diagram of a multi-connector RF antenna hub, useful for the bracket of FIG. 20;

FIG. 24 is a flow chart diagram showing some steps of a method for an employee with a hand-held RFID scanner used in combination with the system of FIG. 1; and

FIG. 25 is a flowchart showing some steps of a method for using stationary readers with the system of FIG. 1, according to one embodiment.

### DETAILED DESCRIPTION

The present invention overcomes the limitations of the prior art by providing a real time electronic article surveillance system that can identify individual items and track the items that is inexpensive and accurate. The system (EASPlus) comprises at least two EPC RFID reader controlled filters that are used when processing the EPC RFID tags (ItemTags) used to track merchandise. The present invention uses an improved tag as described in United States patent application number 2007/0164865 A1, which is incorporated by reference in its entirety. The described new and useful tag overcame the limitations of the prior art. However, these tags occasionally, suffered from false positives. The present invention eliminates false positives by an improvement described herein.

Optionally, in a system designed merely to replace existing EAS systems that do not use EPC capable RFID tags, the ItemTagEAS filter is used. The ItemTagEAS filter has two functions, identifying the store owning the ItemTag and counting the number of tags.

Unlike conventional EAS detectors, which detect and alarm on the condition of “One or More” tags present, with the EASPlus system in the ItemTagEAS mode, it is possible to determine the actual count of ItemTags at each occurrence of a person leaving or entering.

What has been invented is a new concept for In-Store Electronic Article Surveillance that includes activation of a photo recording at the time an EAS tag is taken off premises. Additionally, this system provides a database to track leave event times, location of the sensor where the detection takes place, and the location of the photo and/or audio file. An additional feature of the system is that it can respond to any EPC Gen2 RFID tag, so that upgrading the store to item level tagging does not involve the addition of hardware.

While the EAS Plus device can replace the existing EAS sensors at exits, its real value comes from being able to locate it at or near cash register exits, dressing room doors, restrooms, emergency exits, etc., dramatically increasing the covered area, without compromising store employees or customer privacy. The system can also count tags on rounders, allowing an item count to be performed easily and often. Counting Tags allows detection of hiding—since the total number of Tags, in a restroom or dressing room, for example, should remain unchanged between an Enter and a Leave event. A higher Enter than Leave indicates merchandise left behind, or deliberately hidden.

In operation, the new EAS Plus system utilizes EPC tag technology to create a False Alarm free EAS system. The existing tag infrastructure in the store would be maintained, and no additional employee training is necessary. The system operates autonomously, and if desired, all monitoring functions can be remotely sent to a corporate location. Photographs of people leaving with Tags can provide security personnel with the ability to recognize and monitor the activity of returning customers who have repeatedly set off the sensor system, and might even deny them access to the premises.

The entry level system encodes the EAS Plus tag with only store identity, so that RFID tags on items purchased elsewhere do not set of the system when patrons (at a mall, for example) walk in and out of the store.

The present invention provides:
a. Reduced EAS false alarm rates.
b. Positive (Photographic) records of persons leaving cash registers or store exits with tags.
c. Counting the number of tags in a location such as a clothing rounder (rack) to allow correlation with register purchases at the end of each business day, and to allow restocking during the business day.
d. Counting the number of tags in a private area such as a restroom or dressing room to detect left or hidden items.
e. Attractive monitors integrated into the system that provide advertisement opportunities at exits, and around the store.
f. Audible alerts when a Tag is detected and display of the customer's picture in real time, along with a request to return to the register for tag removal.
g. Motion sensing that allows customer “Thank You for Shopping with Us” acknowledgments when a tag is not detected.
h. Video is only captured when motion is detected, and is not stored unless a Leave event is detected by the presence of a tag.
i. Detecting and counting tag detaches at the register.
j. In the event the store upgrades to full EPC capability, the system can automate checkout using Item Level tagging capabilities of the EPC.
k. With full EPC, the Detach event can be electronically done, by writing a ‘sold’ marker to the RFID tag.
l. Storing counts of door traffic, detach events and door alerts in a database provides the store manager with metrics that indicate how well they are marketing (detaches as a percent of door traffic is a “look to buy” ratio, and door alerts as a percent of door traffic is an indicator of how much theft is going on. Door alerts as a percent of Detach events is a rough estimator of shrinkage.
m. Using a handheld EPC reader, store personnel can find and re-shelve misplaced merchandise.

Other itinerant advantages include:
1. Lower Cost
2. Lower Maintenance
3. Easier operation
4. On Screen guided set up
5. Remote Assistance set up
6. Hands off Upgrades as new software and operating systems emerge.
7. Feature rich system, customizable to client
8. Integrates with existing store network, or operated as service, perhaps purchased and installed by mall security, rather than needing to be a cost to each retailer.
9. Upgradeable to EPC item tagging without hardware change.
10. Less power usage.

The system, methods and devices that implement the embodiments of the various features and advantages of the invention will now be described with reference to the drawings.

The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

In the following description, certain terminology is used to describe certain features of one or more embodiments of the invention.

The term “RFID” refers to radio frequency identification, including but not limited to EPC, standard RFID, near field communications (NFC), and any other means for detecting an article using radio frequency.

The term “rounder” refers to a display that occupies a small circumscribable space and usually comprising clothing hung by hangars.

Various embodiments provide a device and a method for an in-store electronic article surveillance system that can identify individual items and can track the items entrance or exit from a store that is inexpensive and accurate. One embodiment of the present invention provides a system comprising one or more detection devices and one or more than one remote sensor for determining the location and other information from any retail article comprising a EASPlus tag. In another embodiment, there is provided a method for using the system. The system, device and method will now be disclosed in detail.

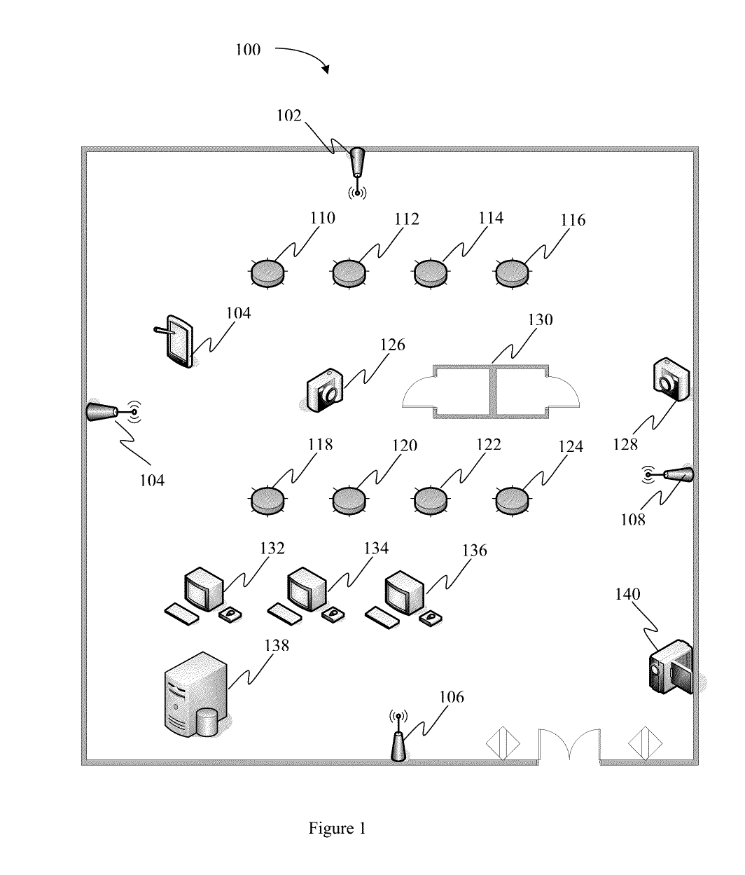

Referring now to FIG. 1, there is shown a diagram of a retail store implementation of an in-store electronic article surveillance system 100 that can identify individual items and can track the items entrance or exit from a store that is inexpensive and accurate.

The system comprises common easily available and inexpensive components, such as computers, displays, keyboard, and audio visual devices (microphones, speakers, and video cameras), network and peripheral interfaces (USB, WiFi, Ethernet, Bluetooth, cellphone Internet access (3G, 4G, and the like) combined with commercially available or custom EPC RFID tags an readers, and custom software for store inventory and security management using the existing training, disciplines and budget commensurate with a stores existing EAS system.

Traditional EAS configurations consist of tags that are detectable by large antenna objects that the customer has to walk through. These must be deliberately placed in the entry/exit paths, so that the customer is forced to walk between them. They are obtrusive and require off hours maintenance to move or fix or upgrade them.

In contrast, the components of the system 100 can be located and relocated anywhere in the store and for less cost than a standard EAS installation. A EAS Plus sensor comprises multiple capabilities, including directed messaging, for example “thank you” or “please return to the register”; general messaging, store advertisements, promotions, entertainment, safety messaging, or general store information, such as, maps, location of goods and services, etc.; the possibility of verbal and visual assistance at locations in the store area, after hours motion sensing with video capture and alerts. These self contained, self-communicating systems, can operate with the store network, or completely independently using cellphone (3G or 4G) internet access, communicating to a service center and then back to the store, and/or by emailing or texting (SMS) store security personnel. All this can is accomplished within the simple EAS (count presense) model described herein. When upgraded to full EPC capability, the means exist to monitor activity around specific merchandise, evaluate the effectiveness of promotions, implement specific local promotions, re-stock specific colors or sizes of merchandise that sell out, provide price checking, with item photographs and descriptions, other branch store inventory locations, and even comparison prices at other competing stores, with instantaneous service, such as, for example, match price if purchased now.

As can be seen, the system 100 comprises one or more than one rounder, one or more than one cameras, one or more than one cash register with at least one sensor attached to the cash register and one or more than one detectors placed throughout the store all connected to one or more than one server. Optionally, store employees can use portable readers to determine the location of tagged items. All of the computers, cash registers, detectors, cameras and readers are operably connected to one another using standard network protocols. In one embodiment the system is started by turning the server on. Once the server has been turned on it clears the EPC event log of any previous events, retrieves instructions from storage to operably begin the system by initializing a SQL database, the readers and reporting functions. Once the server has been started a user can manually select various detectors to initialize or they can be started automatically. For example, the user reinitialize the door sensors and the cash registers to process any tags in the vicinity of those devices. Additionally, the server runs the EPC readers, the inventory database and the file to SQL program that logs events into the database and notifies the cash register and/or monitors of events. The EPC reader comprises instructions operable on a processor to poll the RFID reader for tags. In this embodiment, the EPC reader program requires each reader in the store to monitor tag protects for one second. The instructions then parse the returned list of tags detecting enter and leave events on an EPC identification basis. These events are then added to a log file. After the events have been log in the file they are input into the database. The file to SQL instructions input the information from log file into the database. The program also provides indications of events to the door monitors and the cash registers.

When a customer brings an item to one of the cash registers, the reader attached to the cash register identifies all the items to be purchased by the customer by reading all of the tags. Once the tags have been read, each item is logged into the events log and then the file to SQL program searches the inventory database and identifies the items to be sold. A detach or database logs the items as being detached from the store. The inventory database displays images of each of the items along with the price for each item. A cashier reviews each item visually with the display. If any adjustments need to be made the cashier can adjust amounts or prices as necessary. Once the visual check has been completed by the cashier the amount is totaled and the inventory is updated once payment is processed. As the customer exits the store, the door monitors detect all the tags that customers carrying. The door program comprises instructions such that an image of each customer exiting the store is taken. If the door identification of items does not match the cashier identification of items then the image can be sent to security personnel, and audible or visual alarm can also be sounded notifying the customer and store employees that and ID is being removed that has not been detached. This is a critical component for security personnel, allowing pre-emptive security procedures in future visits.

The system 100 is indistinguishable from ordinary promotional displays, and can be relocated easily. The system 100 is capable of sensing motion, whether a tag is involved or not. Optionally, the system 100 can comprise ‘face tracking’ to enhance the quality of captured facial images, and to deal with multiple person exiting the store at once. The system can also record either single photos, or a short video of leave events. Data storage is conserved by eliminating video/photographic information where no tags are detected. This aspect also provides a level of customer privacy.

Other embodiments of the invention include, face recognition software for repeat offenders, either on entering the store, or when a tag is detected. Sending images via email, sms, or the like to all on duty or selected on duty security personnel for faster more reliable responses to theft occurrences. Providing law enforcement personnel photos, and obtained names. Linking credit card or name information with the photo when a tag is detected at a cash register with a sensor and sending the name as well as the picture to security or law enforcement personnel.

As can be seen, door readers are located at store entry and egress (exit) portals, where persons and store owned products move through in the normal course of business. it performs its function using both video cameras and RFID Readers.

The purpose of door readers is to detect, count, identify (in the case of ItemTagEPC), and log to the database articles that are moving in or out of store-controlled areas. Additionally, Door Readers provide identification information on persons who are moving the ItemTags.

Identity information is acquired passively and actively. An employee carrying ItemTags could also have an EmployeeTagEPC, which would be recorded along with the ItemTag. In all cases the system captures an image of the person or persons in the door area at the time either ItemTagEAS or ItemTagEPC are detected.

Facial recognition software in the Door Unit characterizes features of the image and uses this to determine if the person has previously been seen carrying ItemTags. In the case of an employee, the recognition sequence confirms that the EmployeeTagEPC is being carried by the intended employee, and if not, who is carrying the EmployeeTagEPC.

The Door Readers can also be used to account for VIP visitors. A VIP might be a loyal shopper, who carries a card granting special privilege, such as a Concierge to assist in shopping.

Alternately, a VIP may be a person without a card, but whose picture is in the databases multiple times in connection with unresolved ItemTag Leave events. The system, detecting the entry of such a person, would notify security to the presence of a suspected shoplifter—providing a picture via cellphone. A Concierge would be assigned to ‘assist’ this shopper as well, engaging him/her and walking around the store with them, managing their selections and purchases.

The reader at the Cash Register reads the ItemTag and reports this information to the Database. It places a request for ItemInformation, such as price, description, SKU, discountItem, saleItem, etc. from the database.

In the case of a store implementing full EPC protocols, each tag is uniquely tied to a specific item (for example a red long sleeve shirt, size 16-34, BrandX, placed in inventory on 3 May and on the floor on 10 May with automatic price reduction on 30 August (summer item).

A store implementing only EAS protocols has a tag that is not uniquely tied to an item, but provides an ability to count items. When merchandise is tagged a count may be kept of the number of sweaters, for example, tagged. When the cash register transaction rings up a sweater, and the ItemTagEAS unique number is tied to the sweater being sold, and the overall inventory of sweaters is decremented, and the ItemTag ID queued for a Detach Event.

The function of the Detacher Reader is to identify and count (DetachCount) the detached tags.

In a store implementing only EAS features, the Detacher Reader records and counts the ItemTags removed from merchandise and logs them to the database. The Database compares the DetatchCount with the Cash Register count (see above). If the counts do not balance, a report is generated with a the item description (entered at the Cash Register when the UPC was scanned).

Counting Detach events and correlating them to Cash Register items using the EASPlus system improves on the Senitron Detach concept, since in the Senitron system, the store inventory system had to determine which of the Cash Registered items would have carried tags and used that count as a metric to balance out the Detach events, leaving open the possibility of error. In the EASPlus system, the action registering the ItemTag at the Cash Register tied a unique tag to a unique transaction—which is then ‘checked out’ by comparing the Detach Reader ItemTag event with the local Register.

Balancing CashRegister ItemTags with Detacher ItemTags is one means of preventing a cooperative employee—customer theft, where the employee removes an ItemTag but does not credit the sale at the CashRegister.

Displays are located where they are conspicuous to the customer, in the case of Door units, or convenient, in the case of Help Desks or Cash Register units.

The Display Units comprise serve communication functions:
1. Notifying customers carrying ItemTags that they should return to a Register to complete their transaction (“Please RETURN to the Cash Register. We did not deactivate one of your Tags.”), while displaying their picture.
2. Providing feedback to customers and employees in response to questions
3. Provide Advertising, or Lead Generation aimed at the Customer.
4. Welcoming Customers to the Store.
5. Using facial recognition or Loyalty Tags, welcoming returning clients

An acoustic signal is available, and is used in the following manner:
1. Alert sound, accompanying the video display of the customer carrying an ItemTag, so that he looks to the Monitor.
2. Audio Feedback to Clients and Employees in response to inquiries.
3. Audio Announcements to accompany Advertising
4. In the case of the Help Console—verbal instructions or suggestions.
5. Muzak (background music).

The Database is a collection of information about the store, the transactions, the merchandise and expendables. It uses relational instructions to allow certain data configurations to initiate appropriate responses in the various areas of the store.

For example, at a customer exit door, the presence of an ItemTag belonging to the store will trigger retrieving and storing one of more photographs or a short video, and a Cash Register and return the ItemTag or the Item attached to the ItemTag. If it is a recognized repeat offender (with pictures on file) a request to dispatch security may be sent.

In a similar use, a Door unit placed at the exit aisle of a service area (CashRegister) engenders the same set of responses, changing only the audible alert, perhaps retaining video as well as pictures.

In a different vein, a customer may discover that the restroom needs attention, or specifically, needs towels, toilet paper, or soap. A CustomerTag taken to a Help Console would be scanned and come up with a set of suggested needs, and allow the customer to choose. Alternately, the CustomerTag could be taken to any Register with the same result. By including a specific need, as opposed to a general ‘needs service’, the busy store personnel can manage the immediate need, without making a trip to the restroom and try to guess at the complaint.

A similar CustomerTag will allow a customer to report that a particular size or color of an item is not available where he expects it—and allow the store, either through the Help Console or at a Cash Register, to provide personal assistance or automated responses.

For an added Loyalty Card feature, the contact information of a loyal customer reporting a deficiency might accumulate reward points—or a discount.

In all cases, above, the Database acts as a relational computation engine that queues an action based on a set of detected states. Each piece or element of the EASPlus system is dependent on the Database for communication with other elements. Use of the Database in this fashion constrains the EASPlus to being essentially a State Machine—arguably the most efficient design for this type of application.

External resources can be linked into the EASPlus system, greatly improving store functionality, security and customer experience. Smartphone Apps, text messaging, automated voice calls, and the like serve to connect detected events to human intervention, whether that is to find a lost child or parent, improve the prospects of a sale, or to escort a shopper, with a list of prior unresolved leaves with ItemTags, around the store.

Additionally, alarms and automated lighting systems can interact with the EASPlus system to allow guiding customers to fire exits, illumination of the store on the occurrence of unexpected movement.

The ability to call employees, notify corporate managers, fire and police are systems that are normally stand-alone and paid for out of separate accounts. The opportunity with EASPlus is to merge the detection, and intelligent monitoring systems to minimize false alarms and maximize appropriate responses.

Maintenance of the store included proper and timely attention to the cleanliness and functionality of the sales floor as well as customer service areas like restrooms. Using CustomerTags as a means to elicit customer assistance in replenishing consumables, such as toilet paper, towels, soap, etc. in restrooms, or that an item is not where it should be, or even that something they want is not available in a color or size that they would buy, improves the efficiency of the store, by enhancing customer satisfaction, improving customer revisit rates, and by providing a sense of empowerment to the customer, without inconveniencing him.

A simple swipe of a generic CustomerTag or a customer Loyalty Card at a Help Console allows screen, keyboard, or voice input of messages concerning improvements seen as necessary or desirable by the customer. A similar input using an EmployeeTag can be used to acknowledge or respond to the request

Help Consoles are placed to assist shoppers in getting information about Items stock status and pricing. If discontinued in store, Amazon page displayed to allow ordering.

Initially using EAS concepts, and an already existing budget line, introduce the use of EPC tags into the EAS market. By providing count ratios between door traffic, door alerts and detach events, useable business health metrics are achieved. Advancing to full EPC item level tags, the possibility of an automated store with inventory placement awareness.

Tracking Item level EPC tags permits specific item restocking after the item is removed from the rounder or shelf.

Monitoring and timing Leaves from a rounder or shelf to a cash register and detacher, or from a rounder to the dressing room and then to the cash register provides store managers with customer interest in specific products as well as look and leave events. Items that are never taken from a shelf or rounder indicate little customer interest, another useful piece of feedback.

The system further comprises: a relational database engine, an image signal processing engine, a communications processor, a user interface engine, one or more than one display unit, one or more than one audio input and output, one or more than one electronic camera, a temporary storage, a permanent storage, one or more than one RFID EPC Gen2 reader, and one or more than one RFID EPC Gen2 tags.

Each of the engines comprise instructions operable on a computer or processor to perform the following functions.

The structure presented here is based on states, and can be described as a “State Machine”. This is only one of several programmatical styles that could be applied to meeting the needs of the EASPlus—Senitron Functions.

In a State Machine, an object of the program is considered to be in one of a set of states, and the progression of the program is controlled by something that changes the state. From any state, there are well defined paths to other allowed states. One means of describing this is a ‘State Diagram’ where each state is described, and the paths between states are the actions or processes performed in going from one state to the next. Each State may one or more predescessor states and one or more successor states. A state with no successors is referred to as a “Sink” and a state with no predecessors is referred to as a “Source”. In a manually controlled program, the ON function would source subsequent actions, such as initialization, normalization, calibration, self test, and program start, just to name a few.

For the EASPlus system, the states are the condition of the store and of merchandise and clients. Changes in these states represent actions or processes that move the EASPlus system from one state to another.

The complexity or completeness of the description will depend on how much interaction the EASPlus system is to have with the Store environment in which it is placed. For example, a store security system consisting of motion detection may only depend on the state of the store being Open or Closed. The process of moving from Open to Closed, includes the process of Activating the motion sensing system, and the process moving from Closed to Open would include the process of de-activating the motion control. The included processes of activation and deactivation of the motion control may itself involve many states, and include the states of AlarmOn and AlarmOff. At each level, the description is sufficient to understand the desired performance, until all possible states are described.

A significant feature of State Machines is that the machine is always in a defined state, and a trigger event will cause the program to move to the next state—and the trigger event can be internal or external. If internal, the oveall system is considered to be Asynchronous, and if external, the overall system is Synchronous (to the external event).

An internal trigger may be simply the information that an action has been completed. An external trigger may be simply a timer output.

In the description above, the ‘states’ were static and the paths between the states were actions. The same diagram can be constructed with the description blocks being Actions and the paths between the actions being States. In the example above, the Store Open would be represented as a path to an Action block whose output path is Store Closed. This type of diagram is frequently used to describe program flow (Flow Chart), since the description of the process is the ‘code’ of the program, and the paths between processes are the allowed states. One aspect of this presentation is that the ‘states’ tend to be blended, and program structure can become hard to follow.

While equivalent, these two methods of diagramming a machine should not be mixed, since the distinction of state and process then becomes unclear.

The descriptions of the programs presented below have been segregated into two groups. In the first, (Section III) the basic Subroutine Functions are described algorithmically. This section is followed by a second set describing the EASPlus functions that, when performed in the Store, support the missions stated above (Section I). For example, in Section III, a description of the Means of detecting Tags (ItemTagDetect) is described by the combination what it ‘uses’ and what it ‘does’. ItemTagDetect is a fundamental operation that is carried out in essentially all EASPlus functions, whether at a Door, Cash Register, Rounder, Dressing Room, or Help Console. While ItemTagDetect ‘uses’ an RFID Reader, the Functions of the RFID Reader in the Store include detection of Tags at Doors, Registers, Rounders, etc., and these are found in the RFID Reader Function section.

ItemTagDetect is a process, which is part of one or more larger processes, such as DoorReader, which then is part of the machine that detects and acts on State Changes at various entry and egress points in the store. This Program is responsible for creating and maintaining communications between the EASPlus system components and the store resources. Many of the advanced features available with the EASPlus rely on the existence and availability of facility and personnel. For example, in the Help Console, a request to find a missing child would initiate a call to an available employee—the system uses knowledge of both who is in the call list and who is actually available. If communication is to be via a voice call, SMS or Text or through a custom Smartphone Application, the system knows the preference and backup, and can receive acknowledgement of communication.

Included in the basic program are managing the network security protocols and access to the network from outside (software updates, remote help, etc.). The EASPlus system can be managed or monitored from remote locations, either actively, using VPN (Virtual Private Network), VNC (Virtual Node Controller), or Remote Desktop (an MSwindows feature for controlling a remote resource computer using a local console and display, with the ability of sharing Input and Output capabilities between the remote and local machine, including files); or passively, using a report generator in the Database. The EASPlus system can be upgraded remotely, allowing features to be added or removed from a store, based on need or contract, using the Communication Program.

The system 100 and the method described above require tags. The tags comprise to two types, ItemTagEAS and ItemTagEPC. Both these tags rely on EPC Gen2 RFID tags.

For the EAS function, these tags are only examined for a StoreID—and in fact, all of these Tags could have the same 96 bit EPC ID code. The function of the EAS tag is to indicate presence or absence of a ‘hard tag’ which is a tag attached to merchandise by the store and removed at the cash register. The hard tag is intended to be sensed at Store Egress (Exit) points and to alert the shopper and the Store that the shopper is still carrying an item that has not been properly processed, so that the shopper can return to the Register. The ItemTagEAS is designed to monitor counts of store owned objects coming into and out of the store.

The ItemTagEPC is also an EPC Gen2 RFID tag, and it may be in the tag or on a label, but it carries item specific information, such as an EPC (Electronic Product Code) number. Additionally the ITemTagEPC can contain stock numbers, serial numbers, prices, manufacturing information (locations and dates), color, size, etc. The single physical item carrying the ItemTagEPC can be identified through reading the Tag. The ItemTagEPC is designed to provide Item Level tracking and Identification.

ItemTagEAS and ItemTagEPC may be either passive or semiactive tags. Passive Tags are powered by the energy of the Reader when the tag is being read, similar in concept to a solar battery getting energy from the sun. Attaching a small battery to the Tag allows the system to function at much greater range, since the tag doesn't have to extract energy from the Reader to function (in the analogy to solar cells, solar powered items may not work in dim light, so a solar powered item may also have a battery).

At the most fundamental level, the EASPlus system relies on being able to detect the presence of Item Tags (ItemTagEAS or ItemTagEPC) in specific areas of the store. These areas include Store Ingress and Egress points, Cash Register, Restrooms, Dressing Rooms, Shelves, Rounders, Sale Racks, Customer Service locations, and in general, any place that a customer could go with merchandise. Additionally, detection of Tags in any location where inventory is placed by way of delivery, inventory and stocking.

The ItemTagDetect function allows the EASPlus system to monitor flow of Tags into and out of areas—by noting when they arrive and when they leave (absence).

In another embodiment, each antenna located throughout the store can individually identify and distinguish enters and leaves on a per antenna basis. This additional capability is provided so that antennas at the cash registers can detect EPC's separately from tags elsewhere in the store, such as, for example on the rounder.

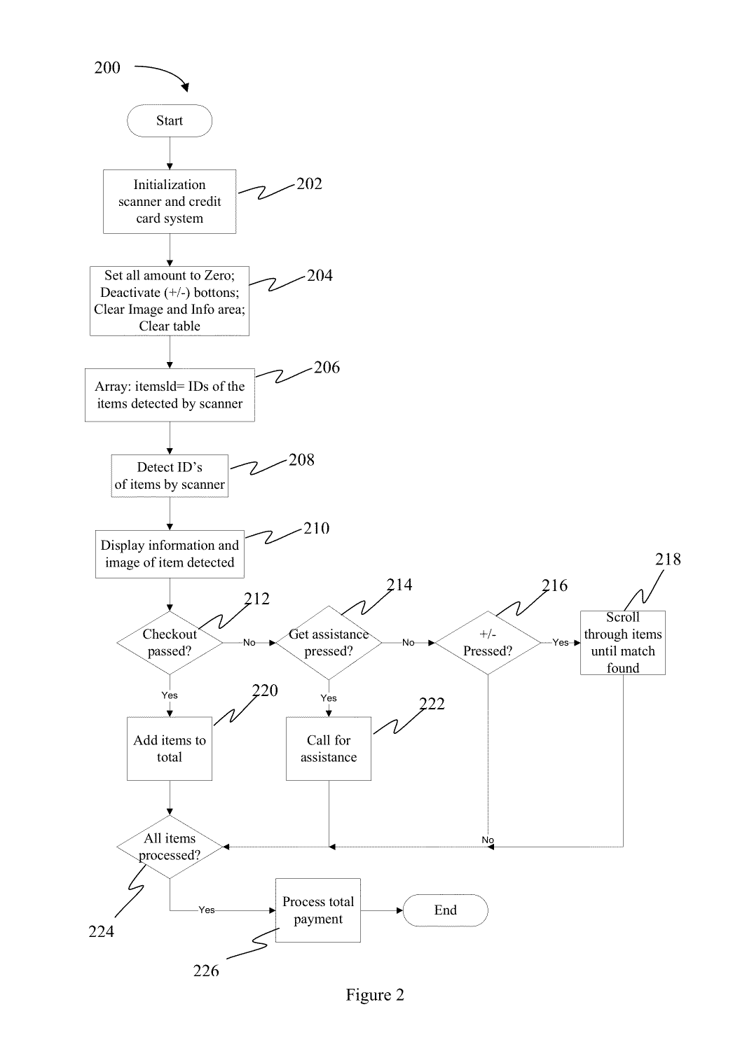

Referring now to FIG. 2, there is shown a flowchart diagram of a retail store implementation of an in-store electronic article surveillance system. First, the system is initialized, including all scanners, readers and credit card systems 202. Then, all amounts are set to zero 204. In step all buttons are deactivated, all images are cleared and information areas and the reader areas are cleared. Next, ID's of items are detected by a scanner 206. Then, the items detected by the scanner are stored in an array 208. Next, information and an image of the item detected is displayed 210. If the checkout procedure is successful (passed) 212, then the items detected are added to a total. Else, if assistance is needed 214, the clerk can press a button to request help 222. If the clerk presses the add or subtract item button 216, a display of all items scanned and available is displayed and the clerk can scroll through the items until a match is found 218. Then, if all items have been processed 224, a total payment is displayed and processed completing the transaction.

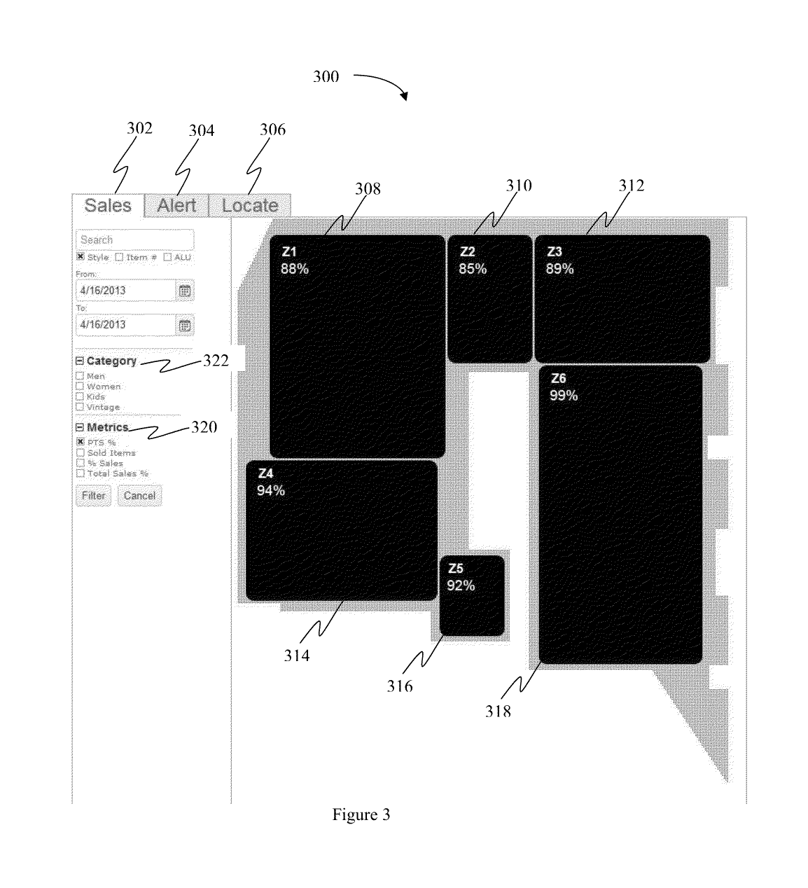

Referring now to FIG. 3, there is shown a screenshot diagram of a user interface displaying sales by zones for a retail store, according to one embodiment. One or more than one zone 308, 310, 312, 314, 316 and 318 can be configured using both the hardware shown in FIG. 1 and the software described in FIG. 2. As will be understood by those with skill in the art with reference to this disclosure, large retailers such as, for example, department stores would need to track inventory for each respective department. The hardware for the system 100, and the software 200 allow for this level of granularity. Alternatively, for a smaller store there may exist only one zone, the entire store that needs to be covered by the hardware shown in FIG. 1.

In this example, the software 200 is configured to display a user interface 300 that comprises three tabs 302, 304 and 306. Additionally, the software 200 can be configured to display the store as the one or more than one zone 308, 310, 312, 314, 316 and 318. This provides a quick view of the entire store. A sales tab 302 provides information on retail sales for each zone covered by the system of FIG. 1. An alert tab 304 provides information designated by the store to trigger an alert. Alerts can be for loss prevention, inventory movement, inventory shortage, etc. The alerts can be customized for each individual stores requirements. A locate tab 306 provides information to locate inventory in the retail space, warehouse space, or a zone.

As can be seen, the sales tab 302 has been selected by a user and a positioned to sell percentage metric 320 has been selected from the list of options comprising the sales tab 302. The software 200 updates the display for each zone 308, 310, 312, 314, 316 and 318 to show the selected metric 320. The positioned to sell percentage metric 320 is displayed in each zone 308, 310, 312, 314, 316 and 318, thereby providing a fast accurate view of current conditions existing in the retail store. Additionally, the sales tab 302 also comprises a category listing 322 that provides additional filters viewable on the display provided by the software 200.

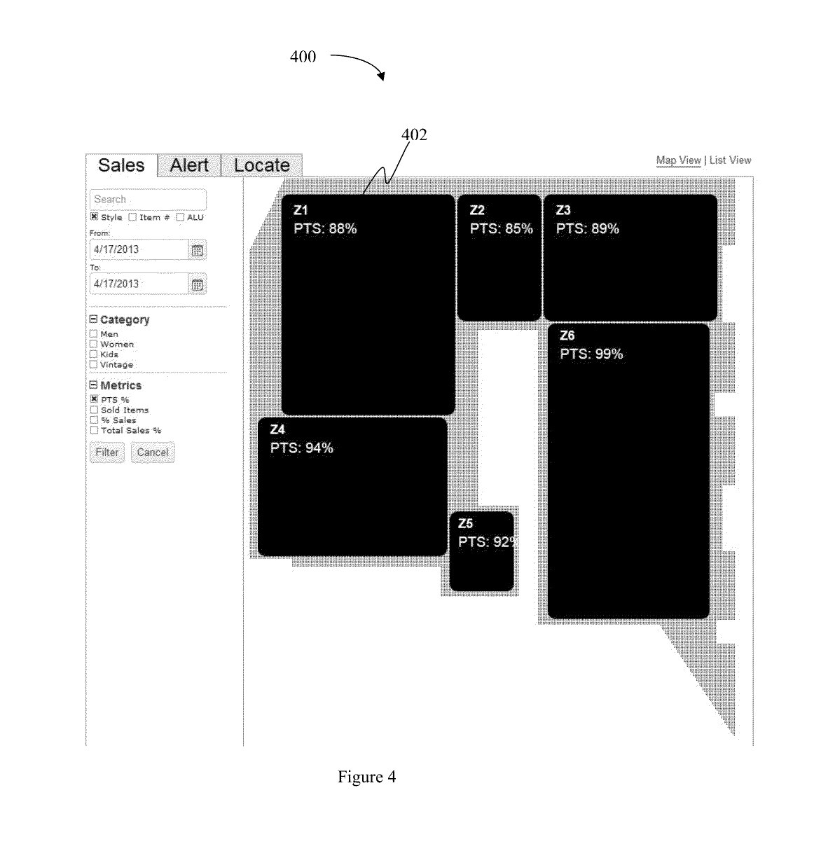

Referring now to FIG. 4, there is shown a screenshot diagram of a user interface displaying sales by zone 400 for a retail store, according to another embodiment. As can be seen in this embodiment, these same positioned to sell percentage metric 320 has been selected by the user. However, in this case, the software 200 is configured to display not only the metric, but title of the metric 402 for each zone 308, 310, 312, 314, 316 and 318.

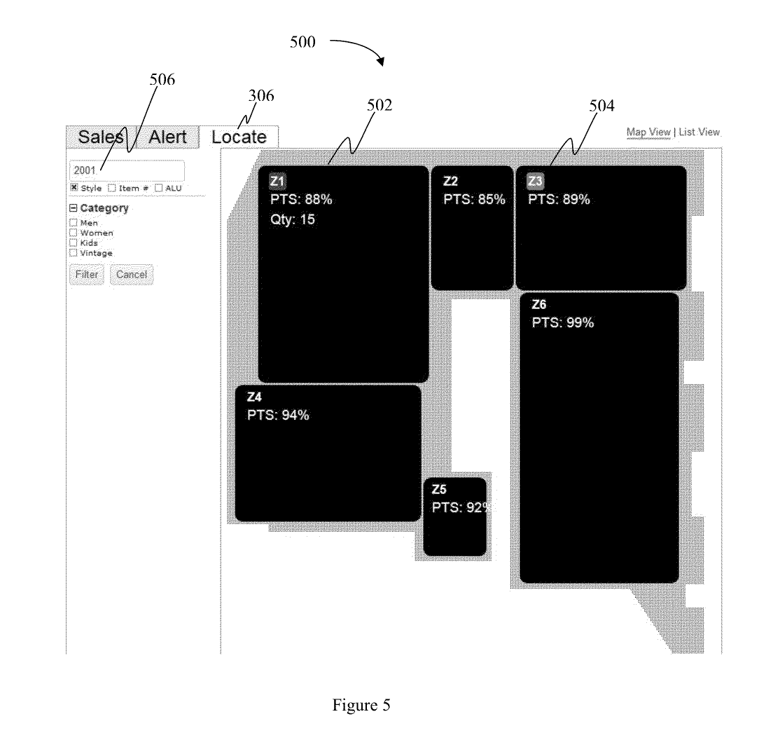

Referring now to FIG. 5, there is shown a screenshot diagram of a user interface displaying quantity of goods by style 500 for each zone of a retail store. The software 200 can be configured to display one or more than one quantity of one or more than one item. As can be seen in this diagram 500, the user has selected a product style 2001 (506) shown in the locate tab 306. Each zone 308, 310, 312, 314, 316 and 318 will then display a quantity of the selected product style. For example, zone z1 displays a quantity 502 of 15 items that match the selected style 506. However, zone z3 does not display a quantity 504 immediately indicating to store personnel that there are no items of style 2001 in that zone. This is extremely useful when store personnel need to locate items to place them back in the particular area of the store that the item belongs. This reduces restocking time, thereby saving the store money.

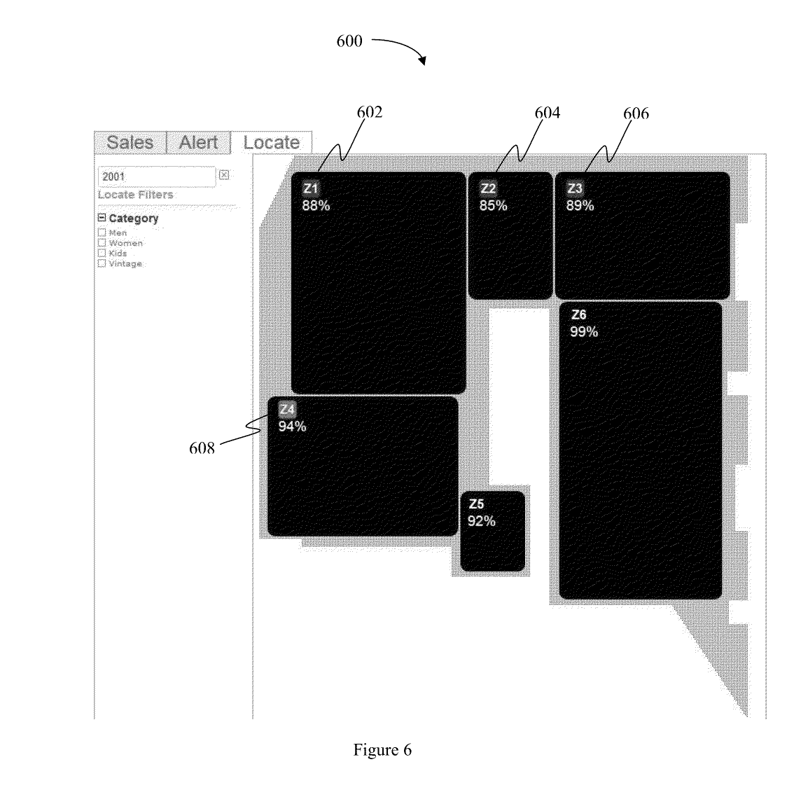

Referring now to FIG. 6, there is shown a screenshot diagram of a user interface displaying the location by style of goods for each zone 600 of a retail store. In this configuration, the software 200 will display the location of the selected style shown in the locate tab 306. As can be seen, zones z1, z2 and z3 602, 604 and 606 respectively indicate that there is less than 90% of the style 2001 in those areas of the store. Zone z4 608 displays that there is over 90% of style 2001 available in that area. Optionally, each of the zones z1, z2, z3 and z4 602, 604, 606 and 608 can be displayed in different colors to visually differentiate those areas that are above a threshold, and those areas that are below a threshold. Additionally the threshold can be set by the user.

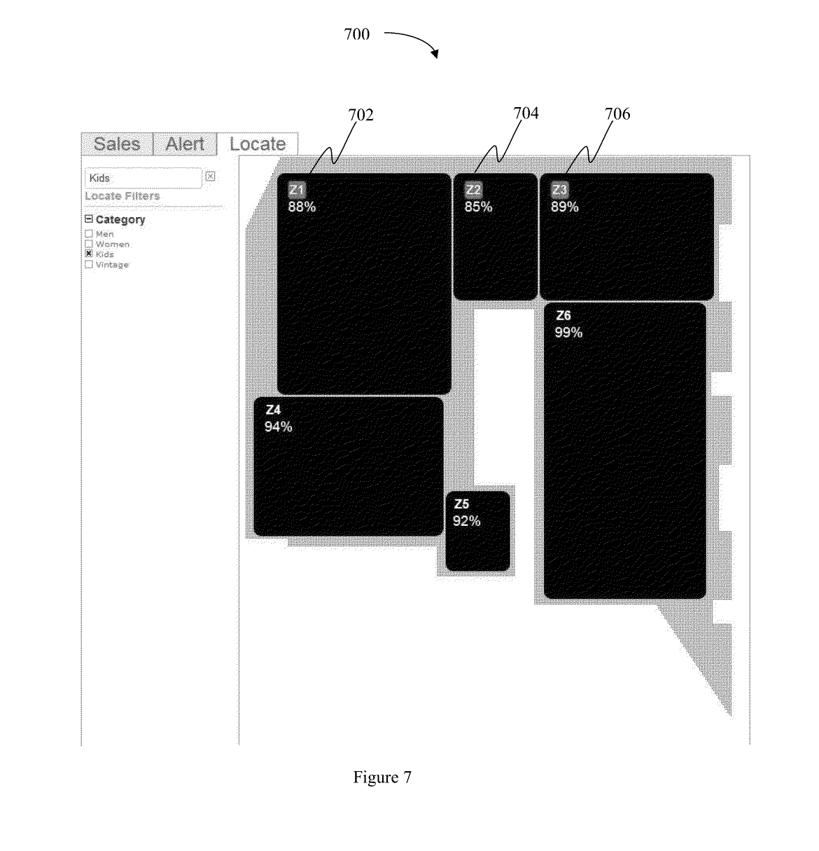

Referring now to FIG. 7, there is shown a screenshot diagram of a user interface displaying the location by category of goods for each zone 700 of a retail store. As can be seen in this embodiment, the user has selected from the locate tab 306 a specific category, in this case kids, and the system 100 and the software 200 retrieve the location of all the RFID that match that particular category and display it on the screen. In this case, zones z1, z2 and z3 702, 704 and 706 each display the percentage of kids styled clothing as a percentage in each area 702, 704 and 706. Optionally, the software 200 can be configured to display each zone that comprises a particular user selected style in a different color to visually differentiate it from the other zones for quick analysis by the user.

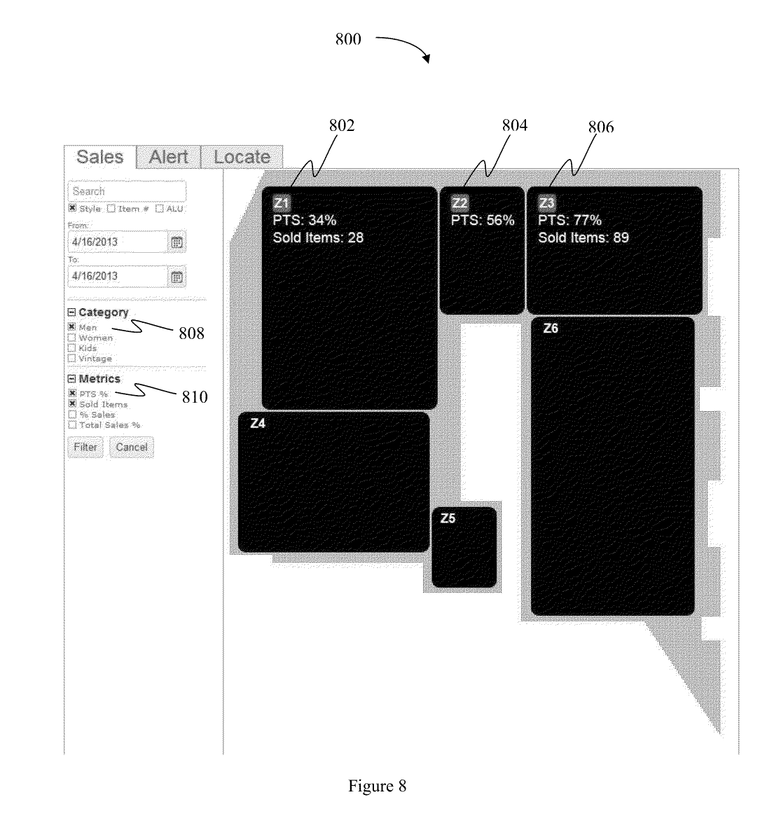

Referring now to FIG. 8, there is shown a screenshot diagram of a user interface displaying sales by category for each zone 800 of a retail store. As can be seen, the user has selected on the sales tab 302 a style search, a category 808 and two metrics 810. Additionally, the user has selected a date range 812. The software 200 then executes instructions to search the database and display the items sold matching the criteria 808 and 810 and the date range 812. The number of items sold is displayed for each zone matching the criteria 808 and 810 and the date range 812. Zones z1 and z3 802 and 806 respectively show items matching the criteria 808 and 810 that were sold in the date range 812. Zone z2 804 matched the criteria 808 and 810, but no items were sold during the selected date range 812. As can be appreciated, this capability of the system 100 and the software 200 can provide on the spot historical and trend data for managers to determine where best to place items of a similar style to maximize sales.

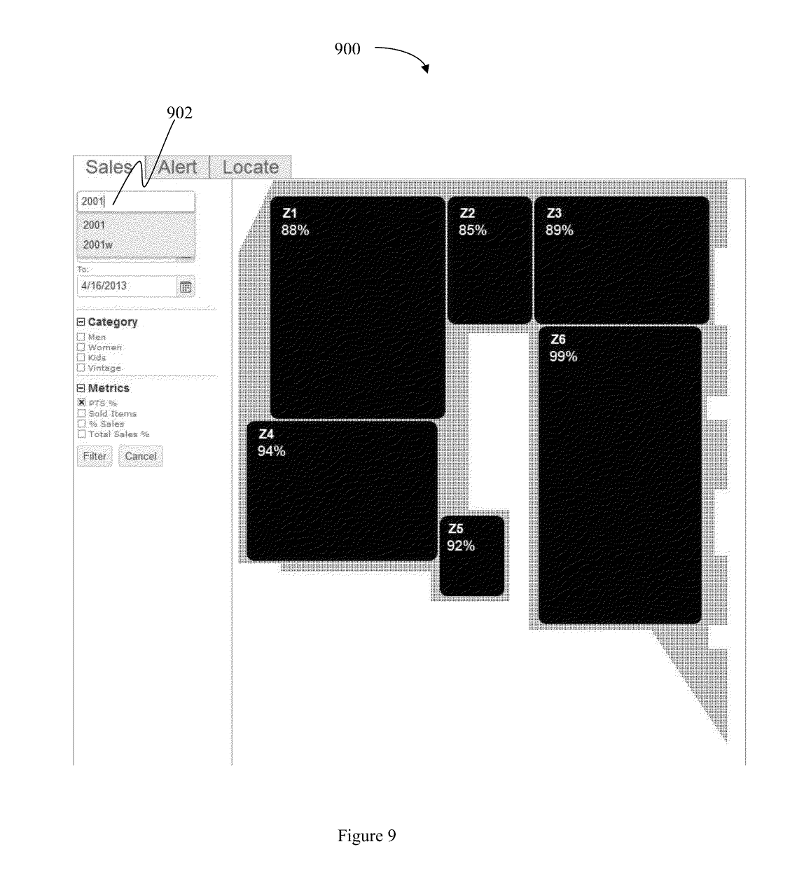

Referring now to FIG. 9, there is shown a screenshot diagram of a user interface displaying sales by style for each zone 900 of a retail store. As can be seen, the software 200 is configured to maintain a look ahead list 902 of all the different styles as the user types in the sales tab 302. This provides quick access to the styles that are available in a particular store, provided that there are multiple stores in a chain. As can be appreciated, this display will speed the process for managers, even if the entire inventory database is kept at a central server location. The styles available for each store will be matched against the inventory for that particular store. Additionally, the software can be configured to look at other stores to determine if there is an abundance of inventory at one store, and a lack of inventory at another. This provides the capability for managers to shift inventory from a store where sales are slow, to a store with better sales, thereby maximizing profit.

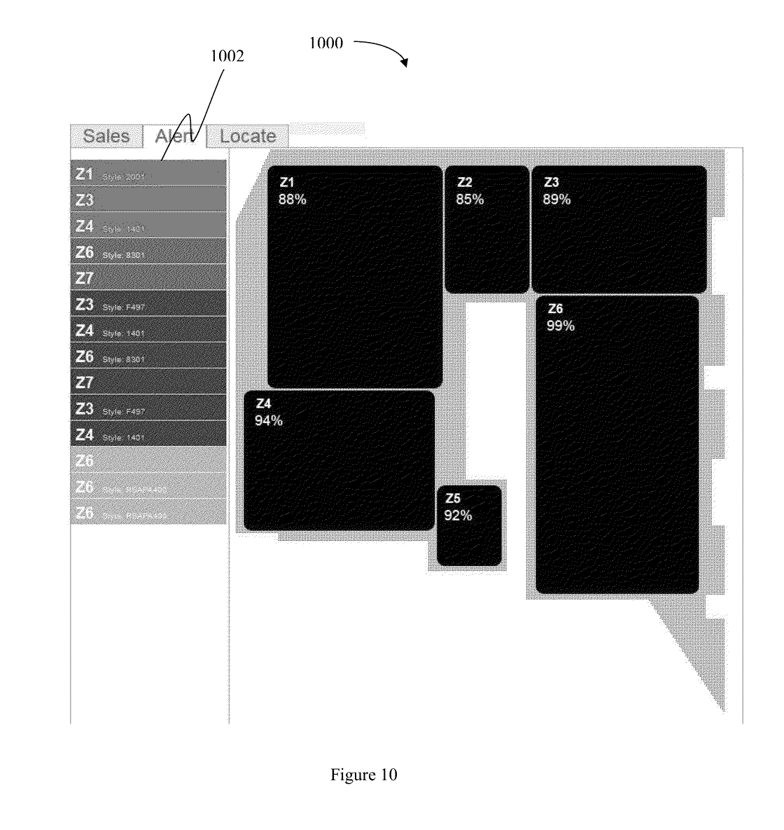

Referring now to FIG. 10, there is shown a screenshot diagram of a user interface displaying alerts 1000 for each zone of a retail store. Additionally, the software 200 can be configured by the user to set alerts 1002 for particular styles in a particular zone. As can be appreciated, this is most useful for alerting managers during sales events when items drop below a certain threshold, or conversely, when items do not reach a certain sales threshold. Optionally, each of the alerts can be color-coded for quick visual determinations by manager. For example, each zone that reaches a sales milestone of over 80% can trigger an alert 1002 that is displayed in green. Alternatively, each zone or a particular zone can have an alert 1002 displayed in red when the inventory levels for a particular style drop below a user set threshold. Thereby alerting the managers so that action can be taken.

Referring now to FIG. 11, there is shown a screenshot diagram of a user interface displaying an alert popup for a selected zone of a retail store. The software 200 can optionally be configured to have the alerts 1102 pop out the display to grab the attention of the user. As can be seen in this embodiment, additional information can be displayed on the alert screen 1102 identifying all the alert parameters set by the user.

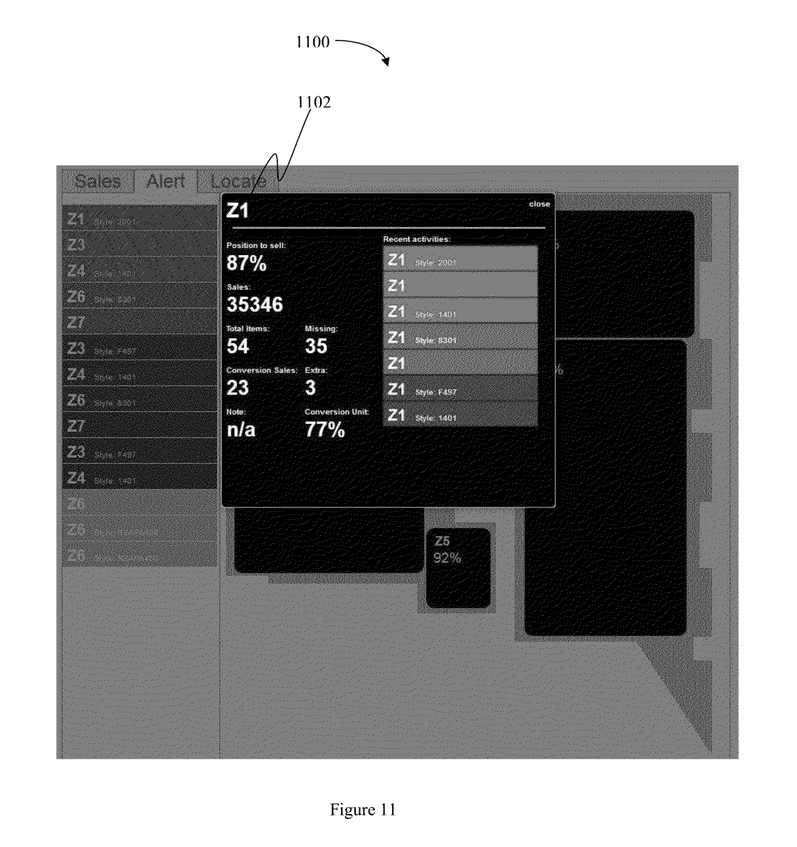

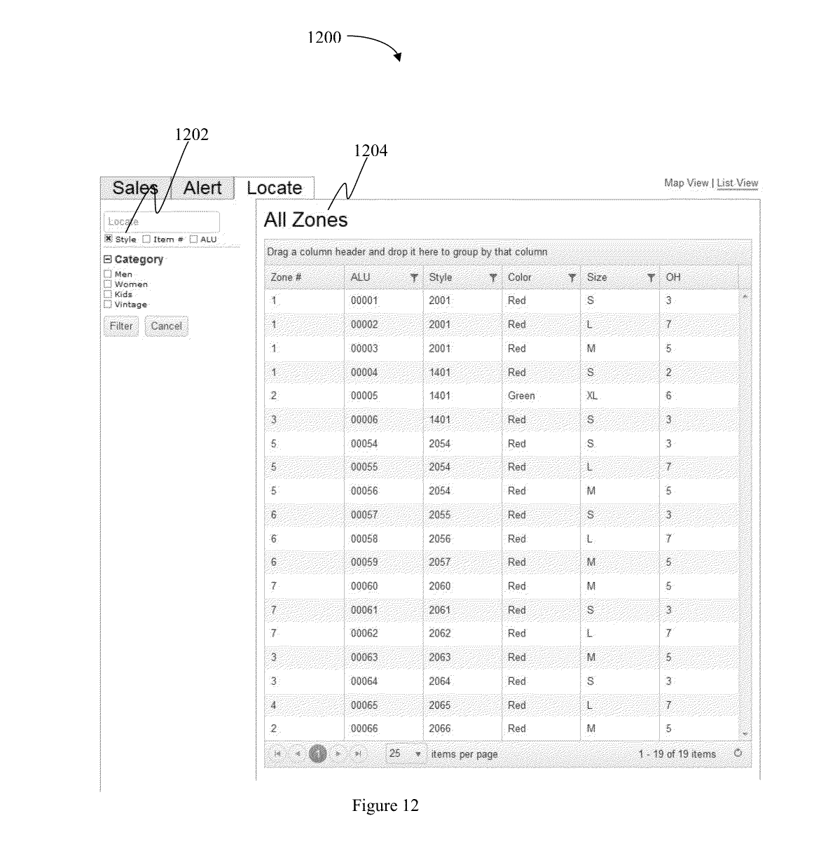

Referring now to FIG. 12, there is shown a screenshot diagram of a user interface displaying item details for all zones of a retail store. The software 200 can also be configured to display a selected style 1202 from the locate tab 306 in a list view 1204. In this configuration, software 200 can display all the information for all zones in a tabular form 1204. This can be useful for records maintenance and printouts.

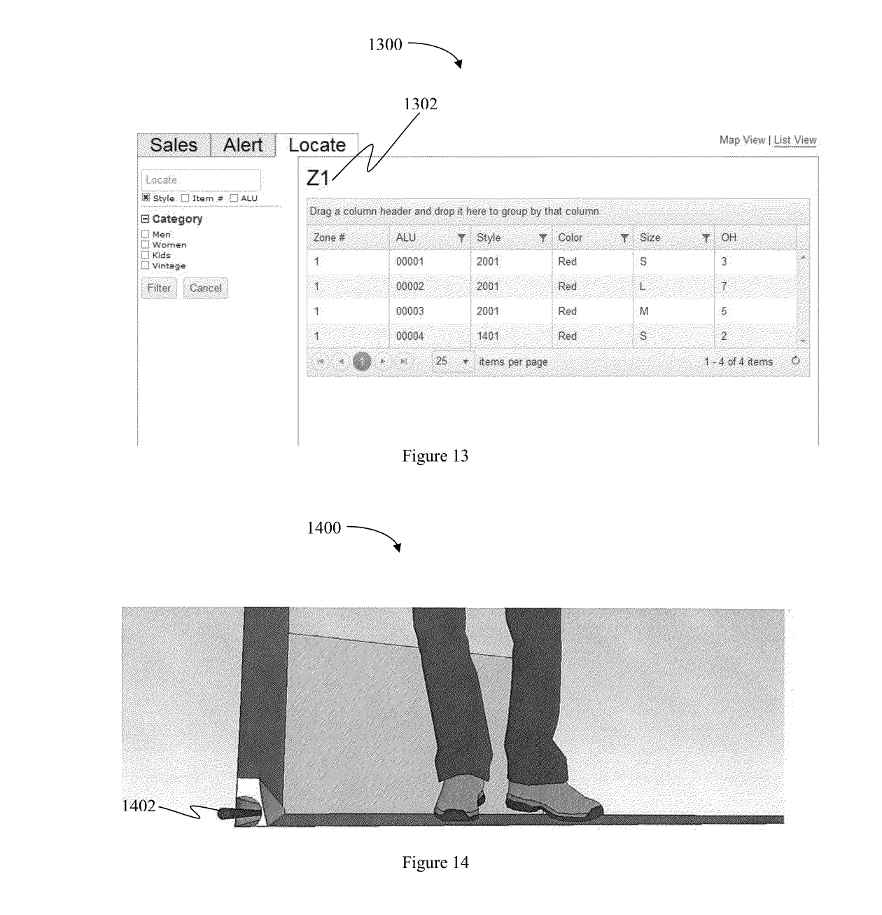

Referring now to FIG. 13, there is shown a screenshot diagram of a user interface displaying item details for a selected zone of a retail store. As can be seen, the software 200 can also be configured to display a particular zone 1302 in the list view 1204. This can also be useful for determining inventory and sales for a particular area of a store.

Referring now to FIG. 14 there is shown a diagram of a baseboard antenna sensor 1400 for RFID tag location, according to one embodiment of the invention. As can be appreciated an antenna 1402 located in the baseboard of a location can be useful for detecting and determining the location of the tags attached to merchandise or other objects that need to be tracked. For example, in a retail store, the baseboard antenna 1402 can be used in halls, corridor, fitting rooms, restroom, shelving, and display cases among others. As will be understood by those with skill in the art with reference to this disclosure, the antenna 1402 itself can be of varying design, depending upon the location and other external factors. The antenna 1402 design can be selected from the group comprising a distributed antenna and a leaky wave antenna. Multiple antennas tuned to different frequencies can also be used to locate a tag. For example, triangulation would require the use of three antennas tuned to a main frequency and to two harmonic frequencies for the tag to be tracked.

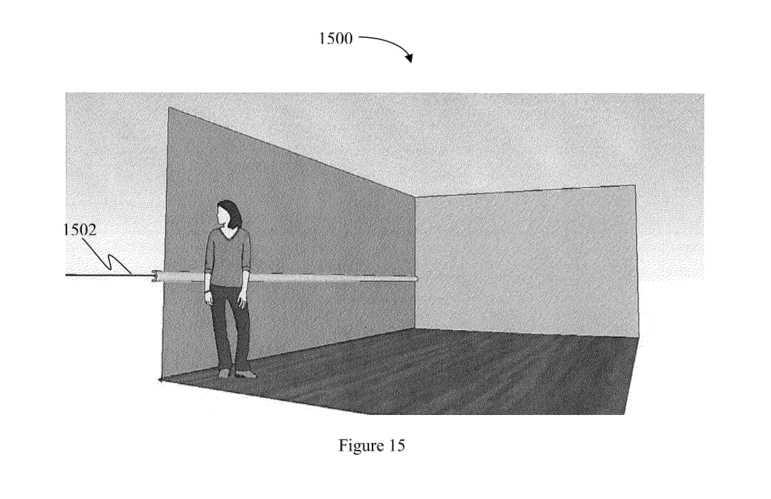

Referring now to FIG. 15 there is shown a diagram of a decorative molding antenna sensor 1500 for RFID tag location, according to one embodiment of the invention. Similar to the baseboard antenna 1402, the decorative molding or rail antenna 1502 can be useful in locations where the baseboard antenna 1402 would not function properly. Additionally, the rail antenna 1502 can be used in conjunction with the baseboard antenna 1402 for triangulation or RFID tag locations.

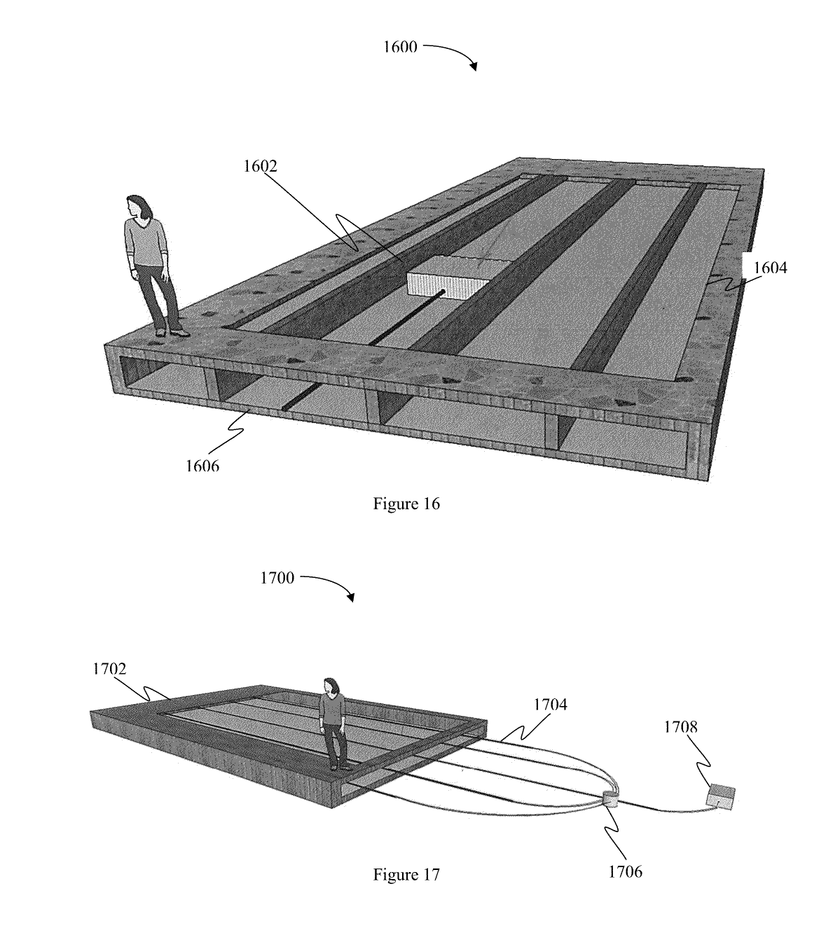

Referring now to FIG. 16 there is shown a diagram of a sub-floor antenna sensor 1600 for RFID tag location, according to one embodiment of the invention. As can be seen, a sub-floor antenna 1602 can be placed underneath the floor structure 1604, and optionally in walls. This type of antenna 1602 is useful as a localized antenna. For example, the sub-floor antenna 1602 can be linked to an alarm that sounds if an item is removed from the location where the antenna 1602 is placed, such as, for example, a jewelry counter. This would alert store personnel that an item of value was removed without permission.

Alternatively, a plurality of sub-floor 1602 or wall antennas 1502 can be used in a similar fashion to cellular towers, where the tag is tracked from one antenna 1402, 1502 and 1602 to the next. In this case, the tag is continuously tracked throughout the store.

Referring now to FIG. 17 there is shown a diagram of a leaky wave sub-floor antenna sensor 1700 for RFID tag location, according to one embodiment of the invention. As can be seen, one or more than one leaky wave antenna 1704 can be place in either the sub-floor 1702 or the walls in a similar manner as shown in FIG. 5. In this embodiment, however, the one or more than one leaky wave antenna 1704 can be attached to a multiplexer 1706 and a RFID transmitter 1708. The RFID transmitter 1708 transmits radar pulses throughout the location. The radar pulses are reflected off the tag and the reflected signal is detected by the one or more than one leaky wave antenna 1704. Using standard radar technology, a precise location for the tag can be determined at all times.

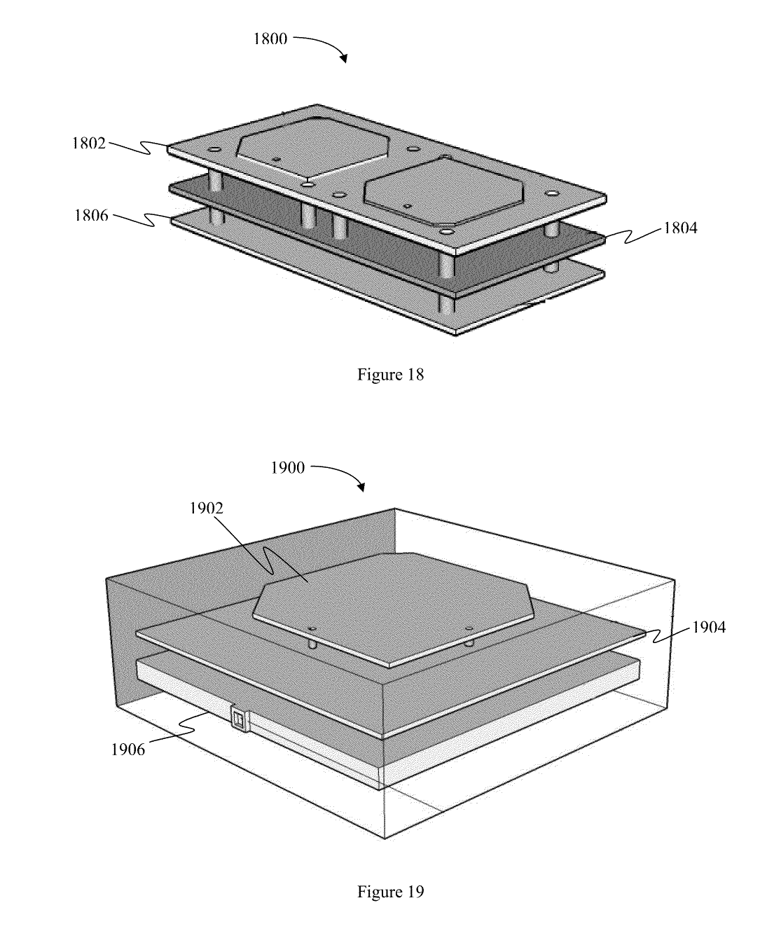

Referring now to FIGS. 18 and 19 there is shown a diagram of a dual RFID antenna 1800 and a diagram of a single RFID antenna with dual independent feeds 1900 useful for tag identification. As can be seen the dual RFID antenna 1800 comprises a Right Hand (RHCP) Circularly Polarized Antenna 1802, a Left Hand (LHCP) Circularly Polarized Antenna 1804, a plate 1806 and a bistatic capable RFID reader 1808. It is common practice to utilize Circularly Polarized Antennas 1802 and 1804 in RFID applications. Most RFID tags antennas are linearly polarized. Some tags employ multiple independent linear polarizations to allow power to be received by the tag regardless of input polarization.

When a Reader or Interrogator utilizes a Circularly Polarized Antenna 1802 and 1804, it is either right 1804 or left hand 1802 polarized. Either polarization 1802 and 1804 will provide energy to an arbitrarily oriented linearly polarized RFID tag antenna. Just as orthogonally oriented linear antennas do not couple to each other, RHCP 1804 and LHCP 1802 antennas do not see each other, so transmitting with RHCP 1804 to a receiver with a LHCP antenna 1802 has a high path loss.

When a RHCP signal is reflected from an object, it becomes LHCP, and vice versa. When an RFID tag ‘backscatters’ radiation to the interrogator (reader) it is also changing the polarization seen by the reader receiver. The consequence of this is that returned signal in a monostatic (single antenna) RFID reader must count on secondary reflections to best receive the returned signal. In a bistatic (two antennas) arrangement or using a single antenna structure with independent RHCP and LHCP feeds overcomes this problem.

Disclosed here is the use of either two separate antennas 1800 or a single antenna 1900 with independent RHCP and LHCP feeds being used with a bistatic capable RFID reader to improve range, read rate and performance of RFID systems. Further, embedding the reader with the antenna structures 1802, 1804 and 1902 greatly reduces the cost and complexity, while allowing the reader—antenna to be connected to the system with standard CAT-5 or CAT-6 internet cable, which provides both power over the Ethernet connection (POE) as well as command and control communication. FIG. 18 and FIG. 19 show popular antenna patch elements mounted in air over a counterpoise 1904 or ground plane 1806. These antennas 1800 and 1900 are inexpensive to make and can provide gains from 5 to 11 dB.

Although combining antennas with readers is not new, nor is Power over Ethernet nor is the concept of utilizing Circular Polarization. What is novel is the combination of POE, bistatic reader and a dual Circular Polarization so that tags receiving LHCP from the reader transmitter reflect back RHCP to the reader receiver, or receiving RHCP, the tags reflect LHCP to the reader. It is envisioned that the reader electronics and the antenna elements can be fabricated on the same physical printed wiring structure, further reducing the cost of the assemblies.

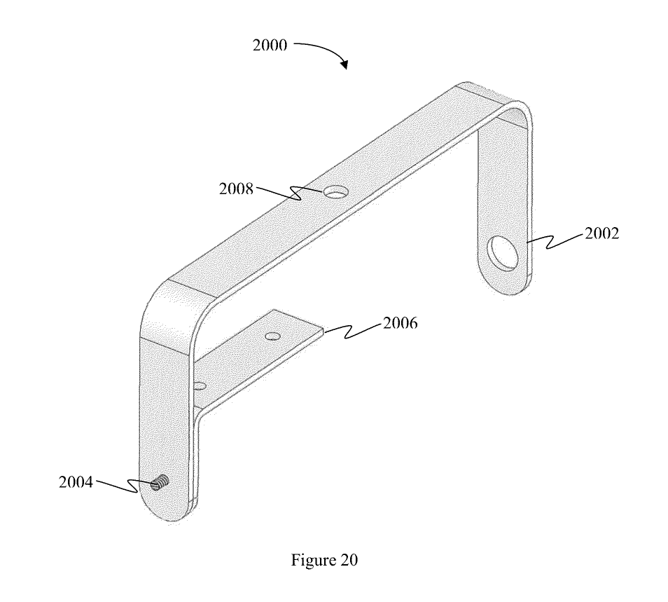

Referring now to FIG. 20 is a diagram of a mobile antenna mounting bracket 2000 useful for mounting, pointing and relocating RFID antennas to increase the RFID antennas' effectiveness and coverage. With all the antennas needed to adequately cover all areas of the store, it is imperative for the system 100 to operate correctly that each individual antenna will need to be adjusted or moved. This becomes more critical will when stores altered displays and change locations for items, and even walls on a regular basis. These changes in floor structure and display structure can adversely affect the ability of the system 100 in the software 200 to perform at optimal levels. Therefore, a bracket as shown in FIG. 2000 can be adapted to quickly and efficiently reposition antennas to compensate for configuration changes in the store. As can be seen the bracket 2000 comprises a horizontal swivel point 2008 affixed to a support member for turning the antenna about a horizontal axis. Additionally bracket comprises two swivel points 2002 and 2004 for adjusting the antenna in a vertical plane 90° relative to the horizontal plane. Additionally, there is an antenna attachment bracket 2006 that can be used to quickly attach an antenna to the bracket 2000. The swivel point 2004 can also act as a quick connect/disconnect point for mounting the antenna attachment bracket 2006. Additionally, the swivel point 2004 acts as a locking mechanism to maintain the RFID antenna at a set angle in the vertical plane. When the bracket 2000 is used in conjunction with the system 100 and the software 200, it provides the capability for quick adjustment and installation of all antennas necessary to ensure 100% inventory read capabilities at all times.

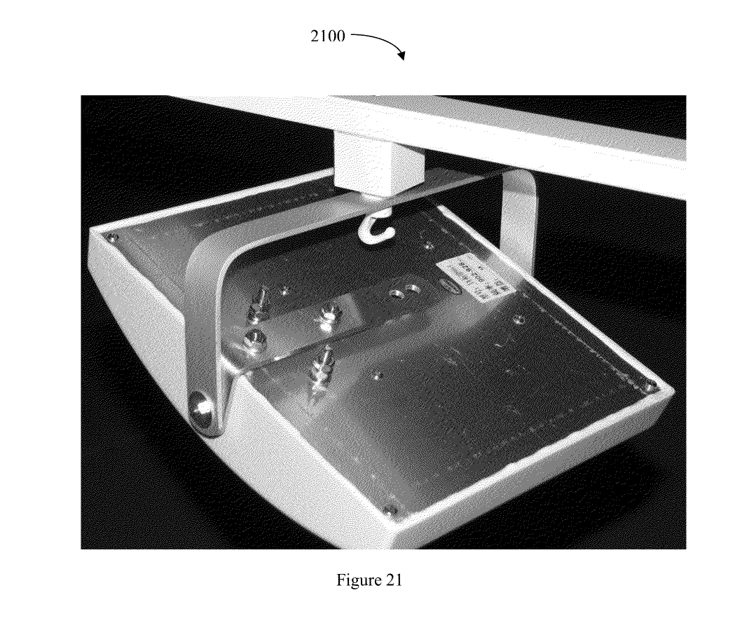

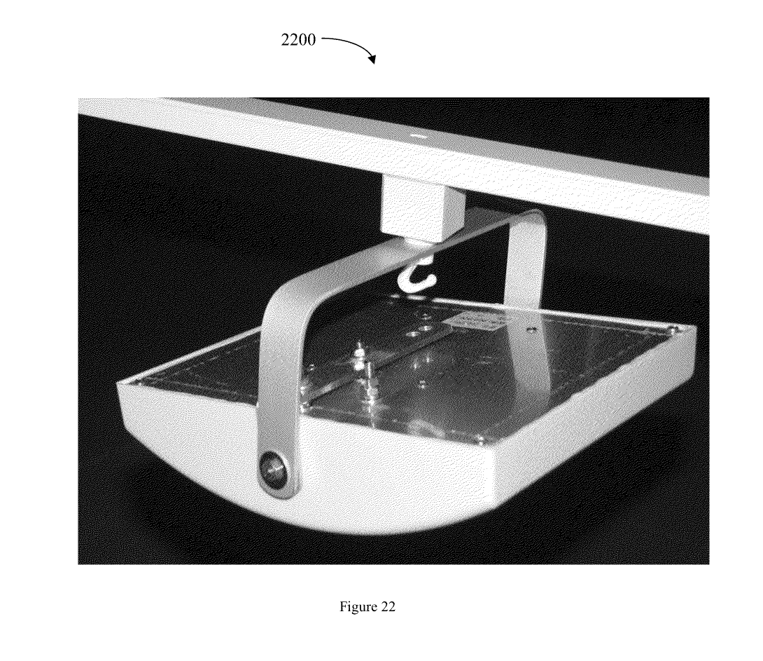

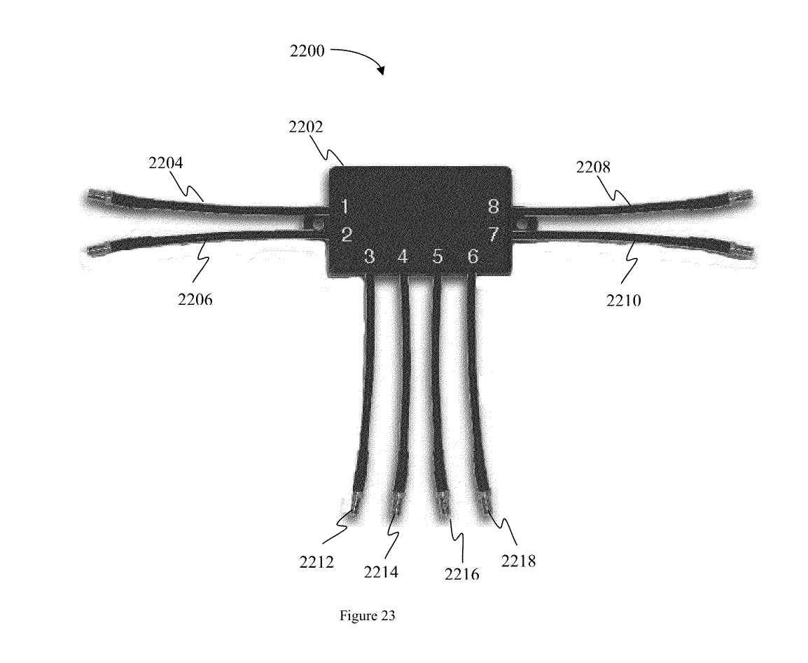

Referring now to FIGS. 21 and 22 there are shown diagrams of the mobile antenna mounting bracket 2000 attached to an RFID antenna 2100. As can be seen, the RFID antenna is positioned on a sliding track 2102 that provides lateral movement along a horizontal plane to reposition the RFID antenna. Additionally will the angle of the antenna has been fixed at an approximate 45° angle to cover a specific area. Additionally, the antenna 2200 has been reposition simply by loosening the swivel point 2004 and then re-tightening the swivel point after the antenna has been repositioned.

Referring now to FIG. 23, there is shown a diagram of a multi-connector RF antenna hub 2300, useful for the bracket of FIG. 20. Although the bracket 2006 is extremely useful, the size of the RFID antennas make connecting them to the system occasionally problematic. Therefore, there was a need to create a multi-connector RF antenna hub 2300 to compensate for the lack of space in certain situations. As can be seen, the 2202 can comprise up to eight cable connectors 2204, 2206, 2208, 2210, 2012, 2214, 2216 and 2218. In this example, the cable connectors 2204, 2206, 2208, 2210, 2012, 2214, 2216 and 2218 coming into the hub are large, that make it very difficult (and ungainly) to attach them to the hub's 2202 original right angle SMA (the spacing is about ¾ inch and the cables are 0.4 inch in diameter, and stiff). Therefore, in order to meet the store requirements for quickly moving and positioning the RFID antennas in the system 100 the cable connectors cable connectors 2204, 2206, 2208, 2210, 2012, 2214, 2216 and 2218 were added.

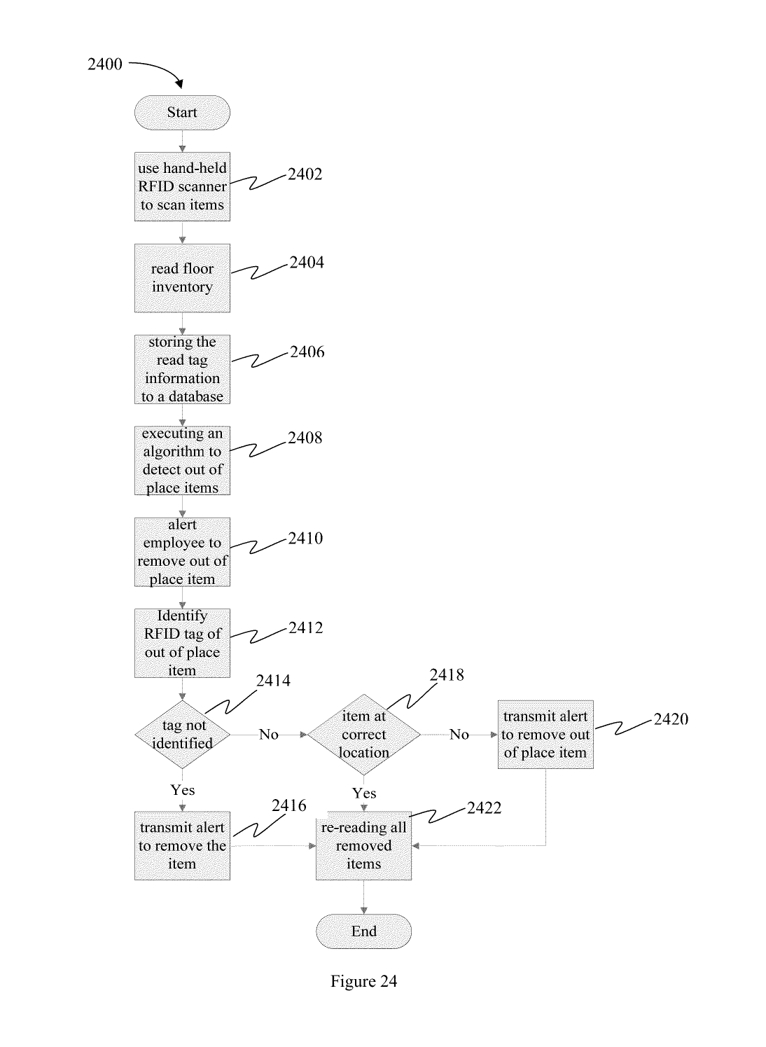

Referring now to FIG. 24, there is shown a flow chart diagram 2400 showing some steps of a method for an employee with a hand-held RFID scanner 2400 used in combination with the system 100. When a store employee 2402 uses a hand held scanner to read floor inventory 2404, the current protocols simply read the tag information to a database 2406. The software 200 further comprises instructions to execute an algorithm to detect ‘out of place’ items 2408. An ‘out of place’ item is any item that is geographically in the wrong location in the store, warehouse or facility. The algorithm comprises instructions for first reading SKU information 2412 from the hand held scanner. Next, the algorithm comprises instructions to determine if any of the SKU information read by the hand held scanner 2404 is an ‘out of place’ item 2414. Then, the system 200 comprises instructions that transmit an alert to the employee with the hand held scanner 2404, thereby indicating that the ‘out of place’ item should be removed from its found location to a predetermined location 2416. Then, the system comprises instructions to identify the RFID tag of the ‘out of place’ item 2414. If the tag is not identified, or an “unknown” tag, the system 200 transmits an alert to the employee to remove the item 2416. Next, the system 200 comprises instructions to determine the ‘out of place’ item's position 2418. If the ‘out of place’ item is being read at a reference location where it does not belong, the system 200 executes instructions to transmit an alert 2420 to the employee to remove the ‘out of place’ item. Then, the system 200 executes instructions to re-read all removed items 2422 and transmit instructions to the employee to take the ‘out of place’ items off the floor, or move them back to active stock.

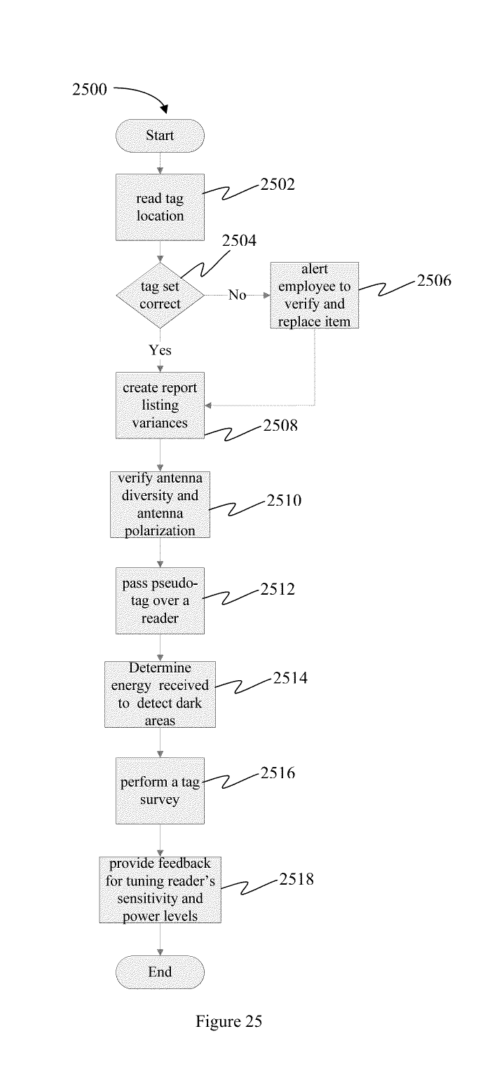

Referring now to FIG. 25, there is shown a flowchart showing some steps of a method for using stationary readers with the system of FIG. 2, according to one embodiment. The system 200 further comprises instructions executable on a processor for first, reading a tag location 2502. Next, the system comprises instructions to determine if an item associated with the tag is supposed to be ‘set’ 2504 (number of SKU's per location) is not correct. If the location is not correct, then an alert is sent to an employee to verify and replace item 2506 if actually missing. Then, a report listing variances from expected stock profile to measured stock profile is created 2508.

Optionally, the system 200 further comprises instructions for surveying the active readers on the floor 2510. Then, verifying antenna diversity 2512 that allows verifying antenna polarization (RHCP, LHCP, Linear). Next, a mock Tag (pseudotag), that responds to the one or more than one readers like standard RFID tags, but reports back to system 200 how much energy is being received by passing the pseudotag over the reader 2514 to provide detection of ‘dark areas’ where tags will not be seen. Then, instructions are executed to perform a tag survey 2516. Information is coded into EPC or pseudotag memory so that the system 200 can record the measurement directly into the database, via the reader. Next, an automated routine is executed in the system 200 using the pseudotag immediate feedback 2518, together with operator information for ‘tuning’ the one or more than one reader's sensitivity and power levels for given locations.

Additionally, ‘marker’ or ‘signpost’ tags on furniture or building structures are used to assist in location metrics. Additionally, these tags allow furniture to be moved around, with the system automatically adding/removing that furniture with it's Tagged Items in the affected merchandizing zones.

As can be appreciated, all of the devices, systems and methods discussed can be used alone or in combination with one another. Each antenna has specific advantages and disadvantages depending upon the location and placement of the antenna and the desired result.

What has been described is a new and improved system and method for a remote control for portable electronic devices that is simple operate and operable with a single hand, overcoming the limitations and disadvantages inherent in the related art.

As can be seen, there are many useful variations of the system possible using current technology with the present invention, as will be understood by those with skill with reference to this disclosure. Although the present invention has been described with a degree of particularity, it is understood that the present disclosure has been made by way of example. As various changes could be made in the above description without departing from the scope of the invention, it is intended that all matter contained in the above description or shown in the accompanying drawings shall be illustrative and not used in a limiting sense.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. A real time electronic article surveillance system that can identify individual items and track the items, the system comprising:
a) one or more than one computer;
b) one or more than one RFID detector communicatively connected to the one or more than one computer;
c) one or more than one display operably connected to the one or more than one computer;
d) one or more than one audio visual devices operably connected to the one or more than one computer;
e) one or more than one network and peripheral interface operably connected to the one or more than one computer;
f) one or more than one RFID tag affixed to one or more than one article communicatively coupled to the one or more than one computer; and
g) instructions executable on the one or more than one computer for:
1) real time inventory and analysis of at least 90% of all the one or more than one RFID tag affixed to one or more than one article;
2) a database; and
3) a user interface.

2. The system of claim 1, where the one or more than one RFID detector can be selected from the group consisting of a baseboard antenna sensor, a distributed antenna, a leaky wave antenna, a decorative molding antenna sensor, a rail antenna, a sub-floor antenna sensor, a dual RFID antenna, a single RFID antenna with dual independent feeds and a bistatic antenna reader.

3. The system of claim 1 further comprising a mobile antenna mounting bracket useful for mounting, pointing and relocating RFID antennas to increase the RFID antennas' effectiveness and coverage, the bracket comprising:
a) a sliding track for positioning RFID antennas;
b) a horizontal swivel point affixed to a support member connectable to the sliding track for turning the antenna about a horizontal axis;
c) a first and a second swivel point connected for adjusting the antenna in a vertical plane 90° relative to the horizontal plane without introducing torque on the suspension system; and
d) an antenna attachment bracket for quickly attaching an antenna to the bracket.

4. The system of claim 3, where the first and second swivel points are a quick connect and disconnect point for mounting the antenna attachment bracket.

5. The system of claim 4, where the first and second swivel points comprise a locking mechanism to maintain the RFID antenna at a set angle in the vertical plane.

6. The system of claim 1 further comprising a multi-connector RF antenna hub.

7. The system of claim 6, where the multi-connector RF antenna hub comprises a plurality of cable connectors.

8. The system of claim 7, where the multi-connector RF antenna hub comprises eight cable connectors.

9. The system of claim 1, where the one or more than one audio visual devices is selected from the group consisting of microphones, speakers and video cameras.

10. The system of claim 1, where the one or more than one network and peripheral interface is selected from the group consisting of USB, WiFi, Ethernet, Bluetooth, cellphone and Internet access.

11. The system of claim 1, where the one or more than one RFID tag is a custom EPC RFID tags.

12. The system of claim 11, further comprises a custom EPC RFID tag operable for:
a) directed messaging communicatively coupled to the one or more than one computer;
b) general messaging communicatively coupled to the one or more than one computer;
c) store advertisements communicatively coupled to the one or more than one computer;
d) promotions communicatively coupled to the one or more than one computer;
e) entertainment communicatively coupled to the one or more than one computer;
f) safety messaging communicatively coupled to the one or more than one computer; and
g) general store information communicatively coupled to the one or more than one computer.

13. The system of claim 12, where the general store information comprises maps, location of goods and location of services.

14. The system of claim 1 further comprising:
a) one or more than one rounder communicatively coupled to the one or more than one computer;
b) one or more than one cameras communicatively coupled to the one or more than one computer;
c) one or more than one cash register with at least one sensor attached to the cash register communicatively coupled to the one or more than one computer; and
d) one or more than one RFID detectors placed throughout the store all communicatively coupled to the one or more than one computer.

15. The system of claim 1 further comprising one or more than one portable RFID scanner to determine the location of the one or more than one articles.

16. A method of using a real time electronic article surveillance system that can identify individual items and track the items, the method comprising the steps of:
a) providing the system of claim 1;
b) initializing the system including all scanners, readers and credit card systems;
c) setting all amounts are set to zero;
d) deactivating all buttons;
e) clearing all images from displays and information areas;
f) clearing readers;
g) detecting ID's of items by a scanner;
h) storing the item ID's detected by the scanner in a storage;
i) displaying information and an image of the item detected;
j) determining if the checkout procedure is successful;
k) adding the items detected to a total;
l) determining if all items have been processed;
m) displaying a total payment due; and
n) processing processed the payment completing the transaction.

17. The method of claim 16 further comprising the steps of:
a) determining if assistance is needed after step j);
b) pressing a button to request help;
c) providing help.

18. The method of claim 17 further comprising the steps of:
a) pressing an add or subtract item button;
b) displaying all items scanned and available items;
c) scrolling through the displayed items until a match is found;
d) adding a missing item;
e) subtracting an item not present;
f) determining if all items have been processed;
g) calculating and displaying a total payment due; and
h) processing the payment due completing the transaction.

19. The method of claim 17, where the RFID detector comprises instructions operable on a processor to poll the RFID reader for tags.

20. A method of using a real time electronic article surveillance system that can identify individual items and track the items, the method comprising the steps of:
a) providing the system of claim 1;
b) executing instructions stored in a storage on the one or more than one computer for:
1) polling the RFID reader for tags;
2) monitoring RFID reader events and protects for one second;
3) parsing a returned list of tags detecting enter and leave events on an EPC identification basis;
4) adding the events to a log file;
5) inputting the events into a database;
6) providing event indications to door monitors and cash registers; and
7) searching and inventory database and identifying articles detected by the RFID detectors.

21. The method of claim 20, further comprising the steps of:
a) detaching articles scanned at a cash register;
b) removing from the database the articles scanned;
c) displaying an image and a price of the articles scanned from an inventory database;
d) reviewing each article visually by comparing the article with the display;
e) adjusting incorrect amounts;
f) adjusting incorrect prices;
g) totaling the price of all articles scanned;
j) receiving payment for all articles scanned; and
k) updating the inventory database removing the articles after receiving payment.

22. The method of claim 21, further comprising the steps of:
a) detecting all the tags as a customer exits the store;
b) imaging each customer exiting the store;
c) determining if the items match the cashier identification of items sold; and
d) sending then the image to security personnel.

23. The method of claim 22 further comprising providing an audible alarm, a visual alarm or both and audio and visual alarm are activate notifying the customer and security personnel that an ID is being removed that has not been detached.

24. The method of claim 20, where the events monitored comprise entrance and egress of RFID tagged articles for a location, movement of RFID tagged article, counting RFID tagged articles and identifying RFID tagged articles.

25. A real time electronic article surveillance system that can identify individual items and track the items, the system comprising:
a) one or more than one electronic product code radio-frequency identification reader;
b) one or more than one controlled filter used when processing the EPC RFID tags electronically connected to the one or more than one reader to track items comprising an improved RFID tag;
c) one or more than one computer communicatively connected to the EPC RFID reader;
d) one or more than one display operably connected to the one or more than one computer;
e) one or more than one network and peripheral interface operably connected to the one or more than one computer;
f) one or more than one RFID tag affixed to one or more than one article communicatively coupled to the one or more than one computer; and
g) instructions executable on the one or more than one computer for real time inventory and analysis of at least 90% of all the one or more than one RFID tag affixed to one or more than one article.

26. The system of claim 25, where the one or more than one controlled filter is an ItemTagEAS filter, where the ItemTagEAS filter is operable to identify a store owning a RFID tag and counting the number of tags.

27. The system of claim 25, where the one or more than one computer comprise a database.

28. The system of claim 27, where the database comprises database fields for:
a) track leave event times field;
b) location field of one or more than one RFID reader where a detection occurred;
c) a photograph field; and
d) an audio file field.

29. The system of claim 25 further comprising RFID reader counts of tags allowing an item count to be performed easily and often.

30. The system of claim 25, where all monitoring functions can be transmitted to a location.

31. The system of claim 25 further comprising instructions for counting the number of RFID tags in a location.

32. The system of claim 31 further comprising instructions for correlating the count with register purchases.

33. The system of claim 25 further comprising instructions for automating customer checkout using Item Level tagging capabilities of the RFID tag.

34. The system of claim 25 further comprising instructions for calculating and displaying metrics selected by a user.

35. The system of claim 28, where the metrics also can comprise a date range.

36. The system of claim 25, where the RFID tags can be either passive, semi-active or both active and semi-active tags.

37. The system of claim 25, where each antenna located throughout the store can individually identify and distinguish RFID tags on a per antenna basis.

38. A method of using a real time electronic article surveillance system that can identify individual items and track the items, the method comprising the steps of:
a) providing the system of claim 18;
b) executing instructions stored in a storage on the one or more than one computer for:
1) polling the RFID reader for tags;
2) parsing a returned list of tags detecting enter and leave events on an EPC identification basis;
4) adding the events to a log file;
5) inputting the events into a database;
6) providing event indications to door monitors and cash registers;
7) searching and inventory database and identifying articles detected by the RFID detectors; and
8) providing a user interface.

39. The method of claim 38, where the user interface can display a layout of a location comprising RFID tagged articles.

40. The method of claim 38, where the user interface can display a layout of a location comprising RFID tagged articles and also display one or more than one sales zones.

41. The method of claim 40, where the user interface can be configured to display sales by zones.

42. The method of claim 41, where the user interface can be configure to display a sales tab, an alert tab and a locate tab.

43. The method of claim 42, where the sales tab can display information on retail sales for each zone.

44. The method of claim 42, where the alert tab can display information designated by a user to trigger an alert.

45. The method of claim 44, where the alerts can be selected from the group consisting of loss prevention, inventory movement and inventory shortage.

46. The method of claim 44, where the alert threshold can be set by a user.

47. The method of claim 42, where the locate tab can display information to locate inventory location covered by the system.

48. The method of claim 42, where each tab can display one or more than one metric.

49. The method of claim 48, where the one or more than one metric displayed can comprise a positioned to sell percentage metric, a date range metric, a style metric, a category metric, a sales by zone metric, a quantity of goods by style metric, a quantity metric, a total sales metric, a loss prevention metric, a shrinkage metric, a location by category of goods for each zone metric, a sales by category for each zone metric

50. The method of claim 49, where the one or more than one metric can be a graphic.

51. The method of claim 49, where the one or more than one metric can be color coded.

52. The method of claim 42, where the alert can be displayed as an alert popup.

53. A method for a real time electronic article surveillance system that can identify individual items and track the items, the method comprising the steps of:
a) using a hand-held RFID scanner in combination with the system of claim 1;
b) providing instructions executable on a processor for:
1) reading floor inventory using the hand held scanner;
2) storing the read tag information to a database;
3) executing an algorithm to detect out of place items, where an out of place item is any item that is geographically in the wrong location, where the algorithm comprises instructions for reading SKU information from the hand held scanner and determining if any of the SKU information read by the hand held scanner is an out of place item;
4) transmitting an alert to the employee indicating that the out of place item should be removed from its found location to a predetermined location;
5) Identifying the RFID tag of the out of place item;
6) determining if the tag is not identified and transmitting an alert to the employee to remove the item;
7) determining the out of place item's position;
8) determining if the out of place item is being read at a reference location where it does not belong and transmitting an alert to the employee to remove the out of place item; and
9) re-reading all removed items RFID tags and transmitting instructions to the employee to take action regarding the out of place items.

54. A method for a real time electronic article surveillance system that can identify individual items and track the items, the method comprising the steps of:
a) providing instructions executable on a processor for:
1) reading a tag location;
2) determining if an item associated with the tag set is not correct;
3) alerting an employee to verify and replace item if actually missing if the location is not correct;
4) creating a report listing variances from expected stock profile to measured stock profile;
5) verifying antenna diversity to verify antenna polarization;
6) passing a pseudo-tag that responds to the one or more than one readers like standard RFID tag over a reader;
7) determining the amount of energy is being received by the receiver using the pseudo-tag to provide detection of dark areas where tags will not be seen;
8) performing a tag survey, using information coded into EPC, pseudo-tag or both EPC and pseudo-tag memory to record the energy measurement directly into the database, via the reader; and
9) providing immediate feedback with operator information for tuning the one or more than one reader's sensitivity and power levels for a given location.

55. The method of claim 54 further comprising instructions for surveying the active readers on the floor.

56. The method of claim 54 further comprising instructions for surveying marker, signpost, or both marker and signpost tags on furniture and building structures to provide location metrics.

57. The method of claim 56, where the marker, signpost, or both marker and signpost tags automatically add, remove or both add and remove furniture and building structures in the affected merchandizing zones.
